(19) United States
(12) Patent Application Publication
(10) Pub. No.: US 2025/0278638 A1
(43) Pub. Date: Sep. 4, 2025

(54) TRAINING AND DEPLOYING HYBRID ARTIFICIAL INTELLIGENCE PROCESSES AND COUPLED EXTRAPOLATION PROCESSES IN DISTRIBUTED COMPUTING ENVIRONMENTS

(71) Applicant: The Toronto-Dominion Bank, Toronto (CA)

(72) Inventors: Amanda EASSON, Toronto (CA); Garon Kar Hon CHU, Toronto (CA); Jihye Jessica HWANG, Toronto (CA); Anna TARNOWSKI, Toronto (CA); Samir Mohamed HUSSEIN, Toronto (CA); Amro Abdallah Abelrazek AMANUDDEIN, Edmonton (CA); Syed Ali Abbas KAZMI, Mississauga (CA); Nishad KHUDABUX, Toronto (CA); Jean-Christophe BOUËTTÉ, Montreal (CA); Sidita ZHABJAKU, Toronto (CA); Nahal ESMAEILI, Toronto (CA); Manigandan CHANDRASEKARAN, Toronto (CA); Aitor DEL COSO, Toronto (CA); Harshul VARMA, Toronto (CA)

(21) Appl. No.: 19/067,383

(22) Filed: Feb. 28, 2025

Related U.S. Application Data
(60) Provisional application No. 63/559,751, filed on Feb. 29, 2024.

(51) Int. Cl. G06N 3/0985; G06N 3/045; G06N 3/047

(52) U.S. Cl. CPC G06N 3/0985; G06N 3/045; G06N 3/047

(57) ABSTRACT

The disclosed embodiments include computer-implemented apparatuses and processes that train and deploy hybrid artificial intelligence processes and coupled extrapolation processes within distributed computing environments. For example, an apparatus obtains event data and indicator data associated with a first temporal interval, and based on an application of a trained artificial intelligence process to portions of the event data and the indicator data, the apparatus generates first output data indicating an expected number of occurrences of a first event during each of a plurality of second temporal intervals. Further, and based on an application of an extrapolation process to the output data, the apparatus generates second output data indicating an expected number of occurrences of a second event during each of the second temporal intervals and modifies an allocation of a computational resource at a computing system in accordance with the first output data and the second output data.

### CROSS-REFERENCE TO RELATED APPLICATION

This application claims the benefit of priority to U.S. Provisional Patent Application No. 63/559,751, filed on Feb. 29, 2024, the entire disclosure of which is expressly incorporated herein by reference to its entirety.

### TECHNICAL FIELD

The disclosed embodiments generally relate to computer-implemented systems and processes that train and deploy hybrid artificial intelligence processes and coupled extrapolation processes within distributed computing environments.

### BACKGROUND

Today, many organizations offer products and services to their customers, and these organizations often provision these products and services to corresponding customers based on a successful processing and approval of corresponding applications that identify and characterize the customers and the products or services. The processing and approval of these applications may be implemented programmatically using one or more computing systems or manually, and in some instances, the manual and programmatic processing and approval of these applications are associated with physical and computational resources maintained by these organizations.

### SUMMARY

In some instances, an apparatus may include a memory storing instructions, a communications interface, and at least one processor coupled to the memory and the communications interface. The at least one processor is configured to execute the instructions to obtain event data and indicator data associated with a first temporal interval, and based on an application of a trained artificial intelligence process to an input dataset that includes portions of the event data and the indicator data, to generate first output data indicating an expected number of occurrences of a first event during each of a plurality of second temporal intervals disposed subsequent to the first temporal interval. The at least one processor is configured to execute the instructions to, based on an application of an extrapolation process to the output data, generate second output data indicating an expected number of occurrences of a second event during each of the second temporal intervals, and perform operations that modify an allocation of a computational resource at a computing system in accordance with the first output data and the second output data.

In other examples, a computer-implemented method includes obtaining, using at least one processor, event data and indicator data associated with a first temporal interval, and based on an application of a trained artificial intelligence process to an input dataset that includes portions of the event data and the indicator data, generating, using the at least one processor, first output data indicating an expected number of occurrences of a first event during each of a plurality of second temporal intervals disposed subsequent to the first temporal interval. The computer-implemented method also includes, based on an application of an extrapolation process to the output data, generating, using the at least one processor, second output data indicating an expected number of occurrences of a second event during each of the second temporal intervals, and performing operations, using the at least one processor, that modify an allocation of a computational resource at a computing system in accordance with the first output data and the second output data.

Additionally, in some examples, a tangible, non-transitory computer-readable medium stores instructions that, when executed by at least one processor, cause the at least one processor to perform a method that includes obtaining event data and indicator data associated with a first temporal interval. The method also includes, based on an application of a trained artificial intelligence process to an input dataset that includes portions of the event data and the indicator data, generating first output data indicating an expected number of occurrences of the first event during each of a plurality of second temporal intervals disposed subsequent to the first temporal interval, and based on an application of an extrapolation process to the output data, generating second output data indicating an expected number of occurrences of a second event during each of the second temporal intervals. The method also includes performing operations that modify an allocation of a computational resource at a computing system in accordance with the first output data and the second output data.

The details of one or more exemplary embodiments of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIGS. 1 and 2A are block diagrams illustrating portions of an exemplary computing environment, in accordance with some examples.

FIG. 2B is a diagram of an exemplary timeline for adaptively training a machine-learning or artificial intelligence process, in accordance with some examples.

FIGS. 2C and 3 are block diagrams illustrating portions of an exemplary computing environment, in accordance with some examples.

FIGS. 4A and 4B are flowcharts of exemplary processes for adaptively training, validating, and testing hybrid, time-series-based, artificial intelligence processes in distributed computing environments, in accordance with some examples.

FIG. 4C is a flowchart of an exemplary process 480 for predicting application volumes during a future temporal interval, in accordance with some examples.

FIGS. 5A and 5B are block diagrams illustrating portions of an exemplary computing environment, in accordance with some examples.

FIG. 6A is a flowchart of exemplary processes for training and testing time-series linear regression processes within a distributed computing environment, in accordance with some examples.

FIG. 6B is a flowchart of an exemplary process for predicting application volumes during a future, target temporal interval, in accordance with some examples

FIG. 7 is a flowchart of an exemplary process 700 for simulating an impact of a modification to a process parameter on outcome data using stochastic processes, in accordance with some examples.

Like reference numbers and designations in the various drawings indicate like elements.

### DETAILED DESCRIPTION

Many organizations offer products and services to their customers subject to a successful processing, and subsequent approval, of a corresponding application and supporting documentation. In some instances, the processing, and subsequent adjudication, or an application for an available product or service often proceeds in accordance with an organization-specific adjudication process, which establishes conditions and constraints on the content of the applications and the supporting documentation associated with a requested products or services. For example, these adjudication processes may enable computing systems associated with, or operated by, the organizations to adjudicate programmatically submitted applications associated with certain applicants, or certain products or services, in accordance with predetermined adjudication rules. In other examples, the adjudication processes may assign submitted applications to underwriters for manual adjudication based on, among other things, digital content maintained by the computing systems of the organizations and provisioned to devices of the underwriters.

By way of example, and upon initial submission of an application for a product or service offered by an organization, one or more computing systems associated with, or operable by, the organization may determine whether the initially submitted application is subject to programmatic adjudication based on, among other things, the conditions and constraints imposed by the organization-specific adjudication process. As described herein, the organization may manage a distributed computing network, and the application may request computational resources available within the distributed computing network during a corresponding temporal interval. If the one or more computing systems of the organization were to determine that the initially submitted application is subject to programmatic adjudication, the one or more computing systems may process the initially submitted application and render a programmatic decision on initially submitted application in accordance with the predetermined adjudication rules. Alternatively, if the one or more computing systems were to determine that the initially submitted application is not subject to programmatic adjudication, the one or more computing systems may assign initially submitted application to an underwriter and may provision digital content associated with the application to a corresponding device associated with the underwriter. The underwriter may review the provisioned digital content and render a manual decision on the initially submitted application, a positive decision.

As described herein, a programmatic or manual denial of the initially submitted application may be associated with, and may result from, one or more errors or omissions within the application or from incomplete or absent documentation. In some instances, an applicant may elect to address the one or more errors or omissions in the initially submitted application, or address the incomplete or absent documentation, and the applicant may resubmit the initially submitted, and updated, application with additional documentation to the one or more computing systems of the organization, which may initiate apply additional adjudication processing to the now-resubmitted application. Further, an initially submitted application, or a subsequently resubmitted application, may be resubmitted to the one or more computing systems of the organization multiple times until that application received a final programmatic or a final manual approval, or alternatively, until the application is abandoned.

The adjudication processes described herein, and the iterative cycles of application submission, programmatic or manual adjudication, and subsequent resubmission, require significant computational and physical resources, which are often incapable of ready or rapid redeployment in view of changes in application volume. For example, while the manual underwriting processes described herein are associated with staffing requirements across multiple geographic locations of the organization, these manual underwriting processes are also associated with physical and computational resources that facilitate a secure maintenance of confidential digital content characterizing submitted applications subject to manual adjudication, a secure communication of this confidential digital content to device or computing systems associated with corresponding underwriters, and a secure review and consideration of the digital content at the devices or computing systems of the underwriters. The allocation of these human, physical, and computational resources is often inflexible and incapable of rapid re-allocation or redeployment absent sufficient notice and advance planning. For example, a rapid, unexpected increase in a volume of submitted applications subject to manual underwriting may strain the existing and secure communications networks and distributed computing environments that facilitate the manual adjudication process, while a rapid, unexpected decrease in a volume of submitted applications subject to manual underwriting may leave unused the existing and secure communications networks and distributed computing environments.

Today, many organizations attempt to characterize and identify potential increases or decreases in a future volume of submitted applications based on qualitative, rules-based approaches that fail to account for many external indicators of these expected increases or decreases in volume, or to link any potential increases or decreases to certain actions of the organizations within the marketplace. While these qualitative processes may provide insights into trends within the marketplace, these processes are often incapable of providing discrete, short-term estimates of application volumes, which would enable these organizations to allocate and distribute efficiently physical and computational resources in a manner consistent with the short-term estimates and further, are often incapable of provide accurate estimates of future application volume over a longer term, such as a three-month period, which would enable these organizations to align the physical and computational resources with expected applications on a long-term basis.

One or more of the exemplary processes described herein may train a time-series-based, hybrid artificial intelligence process to predict, in real-time and simultaneously, an expected number of unique, initially submitted applications subject to manual adjudication by the organization on each day of a future temporal interval, such as, but not limited to, each day during a twenty-eight-day period subsequent to a temporal prediction point. Further, and as described herein, one or more of these exemplary processes may apply a multiplier-based extrapolation process to the output of the trained time-series-based, hybrid neural-network process (e.g., the expected number of unique, initially submitted applications subject to manual adjudication by the organization on each day of the future temporal interval), and based on the application of the multiplier-based extrapolation process to the expected number of unique, initially submitted applications subject to manual adjudication by the organization on each day of the future temporal interval, the exemplary processes may predict an expected, total number of submitted applications subject to manual adjudication by the organization on each day of the future temporal interval.

Further, one or more of the exemplary processes described herein may also train a time-series linear regression process, to predict, in real-time and simultaneously at a temporal prediction point, an expected number of unique, initially submitted applications subject to manual and programmatic adjudication by the organization on a monthly basis during a future, target temporal interval, which may extend three months from the temporal prediction point. The exemplary processes described herein may also apply a staged, multiplier-based process to a predicted output of the trained time-series linear regression process, and based on the application of the staged, multiplier-based process to the predicted output, one or more of the exemplary processes described herein may determine: (i) an expected number of unique, initially submitted applications subject to manual adjudication by the organization as a product of the predicted output of the trained time-series linear regression process and a corresponding net automation rate; and an expected, total number of submitted applications subject to manual adjudication by the organization as a product of the predicted number of unique, initially submitted applications subject to manual adjudication and a corresponding manual resubmission rate.

Certain of these exemplary processes, which coupled together trained, artificial-intelligence processes with multiplier-based extrapolation processes, may enable the one or more computing systems of the organization to determine expected application volumes subject to adjudication a short-term basis (e.g., on each day of a twenty-eight-day temporal interval) and to determine expected application volumes subject to adjudication a long-term basis (e.g., during each month of a three-month period). These exemplary processes may, for example, be implemented in addition to, or as alternative to, existing processes that address expected increases or decreases in application volume on qualitative basis.

Further, while many some existing predictive processes may facilitate a prediction of an occurrences of events during a single, future temporal interval, these existing processes would require multiple, and temporally successive, iterations to predict occurrences of events across multiple, successive future temporals. The need to successive apply these existing processes may not only inflate a computational cost (e.g., in processor cycles, etc.) associated with the predicted occurrences of events across multiple, successive future temporals using these existing predictive, but may also degrade a predictive accuracy of underlying predictive processes during the successive, iterative implementations, which may trigger an additional, and unexpected, retraining and validation of the predictive processes. Certain of exemplary processes described herein, which apply trained, time-series-based, hybrid artificial intelligence process and additionally, or alternatively, a trained, time-series regression process, to corresponding input data sets and predict, simultaneously and in real-time, expected numbers of submitted applications subject to manual adjudication during a plurality of successive, future temporal intervals (e.g., the days and months described herein), may be implemented in addition to, or as alternative to, existing predictive processes associated with successive, iterative implementations across multiple temporal intervals.

a. Exemplary Computer-Implemented Processes for Training and Deploying Time-Series-Based, Hybrid Artificial Intelligence Processes within Distributed Computing Environments

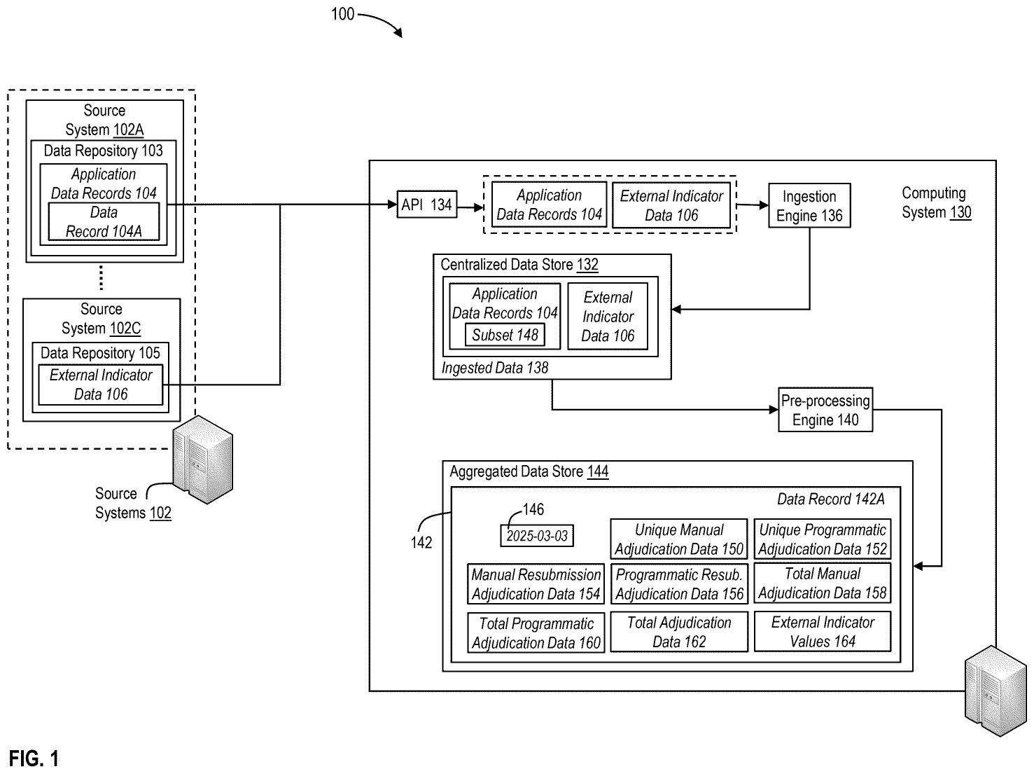

FIG. 1 illustrates components of an exemplary computing environment 100, in accordance with some exemplary embodiments. For example, as illustrated in FIG. 1, environment 100 may include one or more source systems 102, such as, but not limited to, source systems 102A and 102B, and a computing system associated with, or operated by, an organization, such as computing system 130. In some instances, each of source systems 102 (including source systems 102A and 102B) and computing system 130 may be interconnected through one or more communications networks, such as communications network 120. Examples of communications network 120 include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet.

In some instances, each of source systems 102 (including source systems 102A and 102B) and computing system 130 may represent a computing system that includes one or more servers and tangible, non-transitory memories storing executable code and application modules. Further, the one or more servers may each include one or more processors, which may be configured to execute portions of the stored code or application modules to perform operations consistent with the disclosed embodiments. For example, the one or more processors may include a central processing unit (CPU) capable of processing a single operation (e.g., a scalar operation) in a single clock cycle. Further, each of source systems 102 (including source systems 102A and 102B) and computing system 130 may also include a communications interface, such as a wireless transceiver, coupled to the one or more processors for accommodating wired or wireless internet communication with other computing systems and devices operating within environment 100.

Further, in some instances, source systems 102 (including source systems 102A and 102B) and computing system 130 may each be incorporated into a respective, discrete computing system. In additional, or alternate, instances, one or more of source systems 102 (including source systems 102A and 102B) and computing system 130 may correspond to a distributed computing system having a plurality of interconnected, computing components distributed across an appropriate computing network, such as communications network 120 of FIG. 1. For example, computing system 130 may correspond to a distributed or cloud-based computing cluster associated with, and maintained by, the financial institution, although in other examples, computing system 130 may correspond to a publicly accessible, distributed or cloud-based computing cluster, such as a computing cluster maintained by Microsoft Azure™, Amazon Web Services™, Google Cloud™, or another third-party provider.

By way of example, computing system 130 may include a plurality of interconnected, distributed computing components, such as those described herein (not illustrated in FIG. 1), which may be configured to implement one or more parallelized, fault-tolerant distributed computing and analytical processes (e.g., an Apache Spark™ distributed, cluster-computing framework, a Databricks™ analytical platform, etc.). Further, and in addition to the CPUs described herein, the distributed computing components of computing system 130 may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Through an implementation of the parallelized, fault-tolerant distributed computing and analytical protocols described herein, the distributed computing components of computing system 130 may perform any of the exemplary processes described herein to ingest elements of data associated with applications for products or services available for provisioning by the organization, and involving corresponding applicants, one or more prior temporal intervals. By way of example, and as described herein, the organization may manage a distributed computing network, and the applications for the available products or services may include applications by corresponding applications to access computational resources available within the distributed computing network during the one or more prior temporal intervals. Additionally, in some examples, the organization may include a financial institution, and the applications for the available products or services may include applications by for secured lending products during the one or more prior temporal intervals, such as, but not limited to, home loans, home equity lines-of-credit (e.g., HELOCs), and bridge loans associated with real estate secured lending. Further, and through the implementation of the parallelized, fault-tolerant distributed computing and analytical protocols described herein, the distributed computing components of computing system 130 may perform any of the exemplary processes described herein to preprocess the ingested data elements by filtering, aggregating, partitioning, and/or down-sampling certain portions of the ingested data elements, to aggregate the preprocessed data elements, and to store the preprocessed and aggregated data elements within an accessible data repository (e.g., within a portion of a distributed file system, such as a Hadoop™ distributed file system (HDFS)).

Referring back to FIG. 1, each of source systems 102 may maintain, within corresponding tangible, non-transitory memories, a data repository that includes confidential data associated with the applications for the available products or services and characterizing an adjudication, submission, and/or resubmission of these applications using any of the exemplary processes described herein. For example, internal source system 102A may be associated with, or operated by, the organization, and may maintain, within the corresponding one or more tangible, non-transitory memories, a source data repository 103 that includes a plurality of discrete data records, e.g., application data records 104 that identify and characterize corresponding applications for the available products or services during the one or more prior temporal intervals. As described herein, internal source system 102A may correspond to a distributed computing system having a plurality of interconnected, computing components distributed across an appropriate computing network, such as communications network 120 of FIG. 1, and internal source system 102A may maintain source data repository 103 within a portion of a distributed file system, such as a HDFS.

As described herein, each of the applications may be associated with a corresponding of the available products or services described herein and further, corresponding ones of the applications may be associated with, and may involve, a single applicant or alternatively, multiple applicants (e.g., “joint” applicants for the corresponding one of the applications for the corresponding available products or services). Further, in some instances, each of the applications, may be associated with a corresponding, approval decision (e.g., a positive or negative decision) rendered by the organization using any of the exemplary manual or programmatic adjudication processes described herein. By way of example, each of the plurality of application data records 104, such as data record 104A, may be associated with an application for a corresponding one of the products or services and may include, among other things, a unique, alphanumeric identifier of the application, a submission date of the application, a unique, alphanumeric identifier of the corresponding product or service, a date on which the organization rendered a corresponding approval decision for the application (e.g., a “decision” date), and data characterizing a corresponding approval decision (e.g., approve, decline, pending, etc.) and a manual or programmatic adjudication of the application (e.g., a flag indicating manual or programmatic adjudication, etc.).

In some instances, data record 104A may identify and characterize an initial, unique submission of the application for the corresponding product or service, which may be approved by the organization using any of the manual or programmatic adjudication processes described herein. In other instances, an eventual approval of the application for the corresponding product or services characterized by data record 104A may require multiple resubmissions of the application in response to corresponding, and negative, decisions rendered by the organization. For example, the organization may reject manually or programmatically the initial application associated with data record 104A due to a lack of appropriate documentation, and a corresponding customer of the organization may resubmit the application for the corresponding product or service with additional, or alternate, documentation that addresses the prior rejection. In some instances, the resubmitted application may be associated with additional data record within application data records 104, and the additional data record may associate together the unique application identifier of the initially submitted application (e.g., as maintained within data record 104) with the resubmitted application, and may include data characterize the decision rendered by the organization in the resubmitted application.

The disclosed embodiments are, however, not limited to these exemplary elements of data maintained within corresponding ones of application data records 104, including data record 104A. In some instances, one or more of application data records 104 may include, respectively, any additional or alternate elements of data that that characterize the corresponding application for the available product or service, the product or service, and the decision rendered by the organization in the corresponding application using any of the programmatic or manual processes described herein. Further, although stored in FIG. 1 within data repositories maintained by source system 102A, each or a subset of application data records 104 may be maintained by any additional or alternate computing system associated with the organization, including, but not limited to, within one or more tangible, non-transitory memories of computing system 130.

Referring back to FIG. 1, source system 102B may be associated with, or operated by, one or more regulatory, governmental, or reporting entities external to, and unrelated to, the financial institution. For example, source system 102B may be associated with, or operated by, a reporting entity, and source system 102B may maintain, within the corresponding one or more tangible, non-transitory memories, a source data repository 105 that includes elements of external indicator data 106 identifying and characterizing one or more external indicators during the one or more prior temporal intervals. For example, external indicator data 106 may include, but is not limited to, data specifying a total value of home sales in one or more jurisdictions (e.g., in thousands of dollars, etc.), an effective household interest rate and overnight interest rate (e.g., a percentage), housing starts in one or more jurisdictions (e.g., a six-month moving average of a monthly, seasonally adjusted annual rate, etc.), a population of one or more jurisdictions (e.g., in units of thousands), a bond yield (e.g., percentages for one-year, tow-year, etc.), gross domestic product in one or more jurisdictions, and measure of a core inflation rate (e.g., a CPI, etc.) at discrete intervals during the one or more prior temporal intervals. Further, although stored in FIG. 1 within data repositories maintained by source system 102B, each or a subset of external indicator data 106 may be maintained by any additional or alternate computing system associated with the organization, including, but not limited to, within one or more tangible, non-transitory memories of computing system 130.

In some instances, computing system 130 may perform operations that establish and maintain one or more centralized data repositories within corresponding ones of the tangible, non-transitory memories. For example, as illustrated in FIG. 1, computing system 130 may establish a centralized data store 132, which maintains, among other things, one or more of application data records 104 that identify and characterize corresponding applications for the available products or services during the one or more prior temporal intervals and elements of external indicator data 106 that identify and characterize the one or more external indicators during the one or more prior temporal intervals. Computing system 130 may perform operations, described herein, to ingest corresponding ones of application data records 104 and corresponding elements of external indicator data 106 from source systems 102, and centralized data store 132 may, in some instances, correspond to a data lake, a data warehouse, or another centralized repository established and maintained, respectively, by the distributed components of computing system 130, e.g., such an HDFS, etc.,

For example, computing system 130 may execute one or more application programs, elements of code, or code modules that, in conjunction with the corresponding communications interface (not illustrated in FIG. 1), establish a secure, programmatic channel of communication with each of source systems 102, including source systems 102A and 102B, and may perform operations that access and obtain all, or a selected portion, of application data records 104 and the elements of external indicator data 106 maintained by corresponding ones of source systems 102A and 102B. As illustrated in FIG. 1, source system 102A may perform operations that obtain all, or a selected subset, of application data records 104 and from source data repository 103, and transmit the obtained portions of application data records 104 across communications network 120 to computing system 130. Further, source system 102B may perform operations that obtain all, or a selected subset, the elements of external indicator data 106 from data repository 105, and transmit the obtained elements of external indicator data 106 across communications network 120 to computing system 130.

A programmatic interface established and maintained by computing system 130, such as application programming interface (API) 134, may receive the portions of application data records 104 from source system 102A and may receive the elements of external indicator data 106 from source system 102B. As illustrated in FIG. 1, API 134 may route the portions of application data records 104 and the elements of external indicator data 106 to a data ingestion engine 136 executed by computing system 130, and executed data ingestion engine 136 may perform operations that store the portions of application data records 104 and the elements of external indicator data 106 within the one or more tangible, non-transitory memories of computing system 130, e.g., as ingested data 138 within centralized data store 132. Although not illustrated in FIG. 1, executed data ingestion engine 136 may also store, within centralized data store 132, the elements of ingested data 138 in conjunction with additional, or alternate, account data records and elements of external indicator data ingested from corresponding ones of source systems 102A and 102B by executed data ingestion engine 136 during the one or more prior temporal intervals. In some instances, the ingested portions of application data records 104 and the ingested elements of external indicator data 106 may be associated with additional elements of temporal data that characterize a date or time at which executed data ingestion engine 136 received the corresponding portions of application data records 104 and the corresponding elements of external indicator data 106 from source systems 102A and 102B, and stored the corresponding portions of application data records 104 and the corresponding elements of external indicator data 106 within centralized data store 132 (e.g., “ingested” the corresponding portions of application data records 104 and the corresponding elements of external indicator data 106).

A pre-processing engine 140 executed by the one or more processors of computing system 130 may access application data records 104 and the elements of external indicator data 106 maintained within centralized data store 132 (and additional, or alternate, one of application data records or elements of external indicator data maintained within centralized data store 132). Executed pre-processing engine 140 may perform any of the exemplary data-processing operations described herein to parse the accessed ones of application data records 104 and the accessed elements of external indicator data 106, to selectively filter and pre-process the accessed ones of application data records 104 and the accessed elements of external indicator data 106. By way of example, executed pre-processing engine 140 may identify one or more of accessed application data records 104 associated with a submission date that fall either weekend or a holiday, and may perform operations that adjust the submission date to an immediately prior business day (e.g., a Saturday submission date may be adjusted to a prior Friday) or to an immediately subsequent business day (e.g., a Sunday submission date may be advanced to a Monday). Further, in some instances, executed pre-processing engine 140 may also identify, and filter out, incomplete ones of accessed application data records 104, e.g., data records missing decision data, etc.

Further, in some instances, executed pre-processing engine 140 may also perform operations that aggregate selectively the filtered and pre-processed ones of accessed application data records 104 and the filtered and pre-processed elements of external indicator data 106 and generate a plurality of aggregated data records 142, which may be maintained within the one or more tangible, non-transitory memories of computing system 130, e.g., within a portion of aggregated data store 144. By way of example, each of aggregated data records 142 may be associated with a corresponding business day within the one or more prior temporal intervals, and each of aggregated data records 142 may specify, for that corresponding business day: (i) a number of initial submissions of applications adjudicated manually by the organization on the corresponding business day; (ii) a total number of submitted applications adjudicated manually by the organization on the corresponding day (e.g., a sum of the initial submissions subject to manual adjudication and a number of resubmitted applications subject to manual adjudication on the corresponding business day); (iii) a number of initial submissions of application adjudicated programmatically by the organization on the corresponding business day; (iv) a total number of submitted applications adjudicated programmatically by the organization (e.g., a sum of the initial submissions subject to programmatic adjudication and a number of resubmitted applications subject to programmatic adjudication on the corresponding business day); a total number of submitted application adjudicated by the organization on the corresponding business day (e.g., a sum of the total number of applications adjudicated manually and programmatically by the organization during the corresponding business day); and (vi) values of one of external indicators associated with the corresponding business day (e.g., the housing starts, the household interest rate, the population, the number of residential sales, etc.).

For example, as illustrated in FIG. 1, data record 142A of aggregated data records 142 may be associated with a business day on Monday, Mar. 3, 2025, and may include temporal data 146 that specifies the business day of Mar. 3, 2024. In generated data record 142A, executed pre-processing engine 140 may perform operations that parse the accessed ones of application data records 104 and obtain a subset 148 of application data records 104 that include a decision date of Mar. 3, 2025, and as such, that are associated with applications adjudicated by the organization on Mar. 3, 2025 (e.g., through programmatic or manual processes). As described herein, each of the data records within subset 148 (and within application data records 104) may be associated with a corresponding, submitted application for an available product or service, and may include a unique application identifier of the corresponding, submitted application, data that specifies a corresponding submission date, and additional data that indicates a manual or programmatic adjudication of the corresponding, submitted application.

In some instances, and based on the unique application identifier, the submission date, and the additional data indicating the manual or programmatic adjudication, executed pre-processing engine 140 may determine that a first portion of the applications adjudicated on Mar. 3, 2025, represent initial submissions (e.g., application data records 104 include a single reference to each of the application identifiers of the first portion of the applications) and that a second portion of the applications adjudicated on Mar. 3, 2025 represent resubmitted applications (e.g., as application data records 104 include initial and subsequent references to each of the application identifiers of the second portion of the applications). Based on the first portion of the applications adjudicated on Mar. 3, 2025, and on the additional data characterizing the manual or programmatic adjudication of the applications associated with subset 148 of application data records 104, executed pre-processing engine 140 may determine a number of the initially submitted applications subject to manual adjudication on Mar. 3, 2025, and may determine a number the initially submitted applications subject to programmatic adjudication on Mar. 3, 2025. As illustrated in FIG. 1, executed pre-processing engine 140 may perform operations that store the determined number of initially submitted applications subject to manual adjudication on Mar. 3, 2025, and the determined number the initially submitted applications subject to programmatic adjudication on Mar. 3, 2025, within data record 142A, e.g., as respective ones of unique manual adjudication data 150 and unique programmatic adjudication data 152 in association with temporal data 146.

Further, based on the second portion of the applications adjudicated on Mar. 3, 2025, and on the additional data characterizing the manual or programmatic adjudication of the applications associated with subset 148 of application data records 104, executed pre-processing engine 140 may determine a number of the resubmitted applications subject to manual adjudication on Mar. 3, 2025, and may determine a number the resubmitted applications subject to programmatic adjudication on Mar. 3, 2025. As illustrated in FIG. 1, executed pre-processing engine 140 may perform operations that store the determined number of resubmitted applications subject to manual adjudication on Mar. 3, 2025, and the determined number of resubmitted applications subject to programmatic adjudication on Mar. 3, 2025, within data record 142A, e.g., as respective ones of manual resubmission adjudication data 154 and programmatic resubmission adjudication data 156 in association with temporal data 146.

Executed pre-processing engine 140 may also determine a total number of applications adjudicated manually on Mar. 3, 2025 (e.g., as a sum of the determined number of initially submitted applications subject to manual adjudication on Mar. 3, 2025, and the determined number of resubmitted applications subject to manual adjudication on Mar. 3, 2025) and may also determine a total number of applications adjudicated programmatically on Mar. 3, 2025 (e.g., as a sum of the determined number of initially submitted applications subject to programmatic adjudication on Mar. 3, 2025, and the determined number of resubmitted applications subject to programmatic adjudication on Mar. 3, 2025). In some instances, executed pre-processing engine 140 may perform operations that store the total number of applications adjudicated manually and programmatically on Mar. 3, 2025, within data record 142A, e.g., as respective ones of total manual adjudication data 158 and total programmatic adjudication data 160 in association with temporal data 146. Executed pre-processing engine 140 may also determine the total number of applications adjudicated on Mar. 3, 2025, as a sum of the determined, total number of applications adjudicated manually and programmatically ion Mar. 3, 2025, and may store the total number of adjudicated applications within data record 142A, e.g., as respective ones of total adjudication data 162 in association with temporal data 146.

Further, executed pre-processing engine 140 may parse the elements of external indicator data 106 and determine a value of one or more of the external indicators associated with Mar. 3, 2025, and may store the determine values of the external indicators within data record 142A, e.g., external indicator values 164 in association with temporal data 146. As described herein, external indicator values 164 may include, but are not limited to, values of the housing starts, the household interest rate, the population, the number of residential sales on Mar. 3, 2025. Additionally, although not interested in FIG. 1, executed pre-processing engine 140 may perform any of the exemplary processes described herein to generate an additional data record of aggregated data records 142 for each additional business day of the one or more prior temporal intervals associated with application data records 104, and to populate each of the additional data records with temporal data identifying the additional business data, with the numbers of initial and resubmitted applications adjudicated manually or programmatically by the organization on the additional business data, with the total number of applications adjudicated on the additional business day, and with values of external indicators appropriate to, and associated with, the additional business day.

In some instances, computing system 130 may perform any of the exemplary operations described herein to train a time-series-based, hybrid artificial intelligence process, such as a time-series-based, hybrid neural-network process, to predict, at a temporal prediction point, an expected number of unique, initially submitted applications subject to manual adjudication by the organization on each day of a future temporal interval, such as, but not limited to a twenty-eight day period (e.g., a submission of a unique, initial application subject to manual adjudication may correspond to a first event). The exemplary adaptive training processes described herein may, for example, leverage in-time training and validation datasets, and out-of-time testing datasets, associated with temporally distinct subsets of data records maintained within aggregated data store 144 along with corresponding assigned ground-truth labels (e.g., assigned to the data records of aggregated data store 144). For example, the distributed computing components of computing system 130 (e.g., that include one or more GPUs or TPUs configured to operate as a discrete computing cluster) may perform any of the exemplary processes described herein to adaptively train, validate, and test the time-series-based, hybrid neural-network process in parallel through an implementation of one or more parallelized, fault-tolerant distributed computing and analytical processes. Based on an outcome of these adaptive training processes, computing system 130 may generate process coefficients, parameters, thresholds, and other process data that collectively specify the trained time-series-based, hybrid neural-network process, and may store the generated process coefficients, parameters, thresholds, and process data within a locally or remotely accessible data repository.

As described herein, the time-series-based, hybrid neural-network process may include a NeuralProphet™ process couples together a decomposable, time-series forecasting process with autoregression processing that leverages an auto-regressive neural network. The trained, auto-regressive neural network may, for example leverage a fast-need neural network, such as AR-Net™, and the hyperparameters of the auto-regressive neural network, and the parameters of the decomposable, time-series forecasting process, may be tuned adaptively and optimized during the exemplary training, validation, and testing processes described herein using a grid search process, a random search process, or a Bayesian optimization process, such as an Optuna™ optimization process.

By way of example, a predictive output of the trained time-series-based, hybrid neural-network process at a particular temporal position, tᵢ, within the future temporal interval (e.g., the expected number of unique, initially submitted applications subject to manual adjudication by the organization on a particular day) may be expressed as a sum of contribution from multiple, discrete process components, as:

$$y ( {t}_{i} ) = T ( {t}_{i} ) + S ( {t}_{i} ) + E ( {t}_{i} ) + A ( {t}_{i} ) + L ( {t}_{i} ) ,$$

where Y(tₜ) represents the expected number of unique, initially submitted applications subject to manual adjudication by the organization at temporal position t; within the future temporal interval, T(tₜ) represents a contribution of trend to the predictive output at temporal position tᵢ, S(tₜ) represents a contribution of seasonality effects to the predictive output at temporal position tᵢ, E(tᵢ) represents a contribution of an event and holiday effects to the predictive output at temporal position tᵢ, F(tₜ) accounts for regression effects at temporal position tᵢ due to future-known exogenous variables, A(tᵢ) accounts for regression effects at temporal position tᵢ due to past observations, and L(tₜ) accounts for regression effects at temporal position tᵢ due to future-known exogenous lagged observations of exogenous variables.

In some instances, the trend may be modelled within the time-series-based, hybrid neural-network process (e.g., the NeuralProphet™ process) as a continuous, piecewise linear series between corresponding pairs of temporal change points, as:

$$T ( {t}_{i} ) = m + k ( {t}_{i} - {t}_{0} ) ,$$

where m represents a configurable offset, k represents a configurable growth rate, and t₀ represents an initial, temporal position, e.g., an initial one of a pair of temporal change points. The growth rate, k, may be held constant by the time-series-based, hybrid neural-network process between each pair of changepoints, and the variation in the growth rate between pairs of change points, and the number of changepoints across the future temporal interval, may represent configurable parameters of the time-series-based, hybrid neural-network process.

Further, the contribution of seasonality effects to the predicted output of the time-series-based, hybrid neural-network process may be modelled as a combination of a configurable number of Fourier terms with a specific, and configurable, periodicity, as

$${S}_{P} ( t ) = {\sum }_{j = 1}^{k} ( {a}_{j} cos ( \frac{2 π jt}{p} ) + {b}_{j} sin ( \frac{2 π jt}{p} ) ) ,$$

where k represents the number of Fourier terms and p represents the periodicity, which may be established daily, weekly, or yearly basis, e.g., to represent daily, weekly, or yearly seasonality. In some instances, the time-series-based, hybrid neural-network process may account for the effects of events and holidays on the predicted output through an introduction of a binary variable that accounts for the occurrence of the holiday or event within the future temporal interval.

As described herein, the contribution of regression effects due to future-known exogenous variables (e.g., those exogenous variables associated with known past and future values) on the predicted output of the time-series-based, hybrid neural-network process may be modelled as, and may be accounted for by, a linear regression process based on past and future values. Examples of these linear regression processes may include, but are not limited to, a least-squares process or other appropriate linear regression process. Further, the contribution of regression effects due to past observations and the contribution of regressions effects due to lagged observations of exogenous variables (e.g., “lagged” regressors) to the predictive output of the time-series-based, hybrid neural-network process may be determined using a trained, auto-regressive neural network, such as, but not limited to, an auto-regressive, fast-need neural network (e.g., AR-Net™ implemented by the NeuralProphet™ process).

In some instances, the trained, auto-regressive neural network may, upon establishment by the one or more processors of computing system 130, determine the regression effects at temporal position tᵢ due to past observations, and determine the contribution of these regression effects on the predictive output of the time-series-based, hybrid neural-network process, by regressing over the actual number of unique, initially submitted applications subject to manual adjudication by the organization at discrete temporal positions within a prior temporal interval. For example, the prior temporal interval may correspond to a two-week interval, and the auto-regressive neural network may, at a corresponding temporal prediction point, determine the regression effects of past observations by regressive over the actual number of unique, initially submitted applications subject to manual adjudication on each day on a prior, fourteen-day interval.

Further, to account for the lagged regressors, the trained, time-series-based, hybrid neural-network process may cause computing system 130 to establish a separate, and distinct, auto-regressive neural network for each of the lagged regressors (e.g., in accordance with hyperparameters consistent with the auto-regressive neural networks described herein). Based on the values associated with the past observations for each of the lagged regressors, the regressor-specific, auto-regressive neural networks may determine the regression effects at temporal position tᵢ due to each of the lagged regressors, and determine the contribution of these regression effects on the predictive output of the time-series-based, hybrid neural-network process, by regressing over the corresponding values of the lagged regressors at discrete temporal positions within the prior temporal interval described herein, such as, but not limited to, a fourteen day interval.

As described herein, based on an application of the trained, time-series-based, hybrid neural-network process to a corresponding input dataset associated with a temporal prediction point, certain of the exemplary predictive processes described herein may facilitate a prediction, simultaneously and in real-time, of an expected number of unique, initially submitted applications subject to manual adjudication by the organization on each day of a future temporal interval, such as, but not limited to, each day of a one-month interval (e.g., a submission of a unique, initial application subject to manual adjudication may correspond to a first event). Further, and as described herein, computing system 130 may also perform operations that apply a multiplier-based extrapolation process to the output of the trained time-series-based, hybrid neural-network process (e.g., the expected number of unique, initially submitted applications subject to manual adjudication by the organization on each day of the future temporal interval), and based on the application of the multiplier-based extrapolation process to the expected number of unique, initially submitted applications subject to manual adjudication by the organization on each day of the future temporal interval, computing system 130 may predict an expected, total number of submitted applications subject to manual adjudication by the organization on each day of the future temporal interval (e.g., both the unique, initially submitted applications and resubmitted applications, which correspond to respective second events).

For example, the multiplier-based extrapolation process may determine, at a temporal prediction point of the trained, time-series-based, hybrid neural-network process, a proxy multiplier as a rolling average of a ratio between a total number of applications subject to manual adjudication by the organization and a number of the initially submitted applications subject to manual adjudication across a prior temporal interval, as:

$${multiplier}_{t} = \frac{( {prop}_{t - 1} + {prop}_{t - 2} + … + {prop}_{t - N} )}{N} ,$$

where propᵢ represents the ratio between the total number of applications subject to manual adjudication by the organization and the number of the initially submitted applications subject to manual adjudication at a corresponding day i, and where N is equivalent to the number of days in the prior temporal interval, such as, but not limited to, fourteen. In some instances, computing system 130 computing system 130 may determine, at each day of the future temporal interval, the expected, total number of submitted applications subject to manual adjudication by the organization on that day of the future temporal interval (e.g., both the unique, initially submitted applications and resubmitted applications) as a product of the proxy multiplier and the expected number of unique, initially submitted applications subject to manual adjudication by the organization on that day of the future temporal interval).

Through an application of the trained, time-series-based, hybrid neural-network process to a corresponding input dataset associated with a temporal prediction point, and through an application of the multiplier-based extrapolation process to the output of the trained time-series-based, hybrid neural-network process, computing system 130 may generate, simultaneously and in real-time, the expected number of unique, initially submitted applications subject to manual adjudication by the organization, and the expected, total number of submitted applications subject to manual adjudication by the organization, on each day of a future temporal interval, such as, but not limited to, the one-month interval described herein. In some instances, output data indicative of the expected number of unique, initially submitted applications, and the expected, total number of submitted applications, subject to manual adjudication by the organization on each day of a future temporal interval may inform a decision by the organization to allocate, or to modify a prior allocation of, resources in support of the manual adjudication of these applications on each day of the future temporal interval.

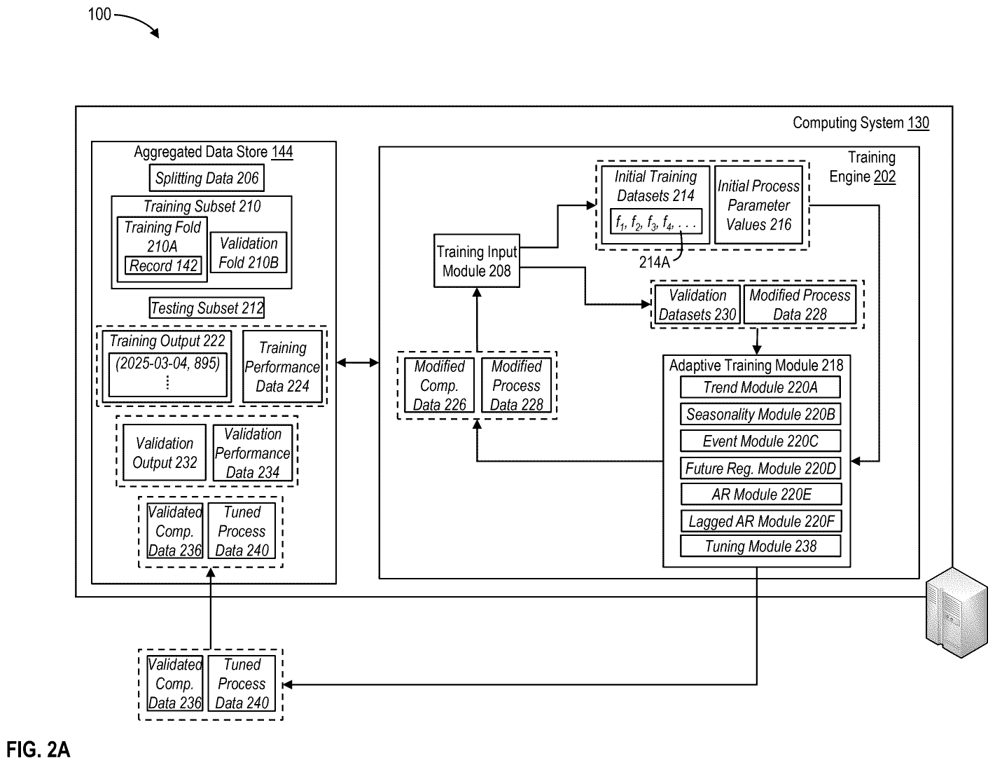

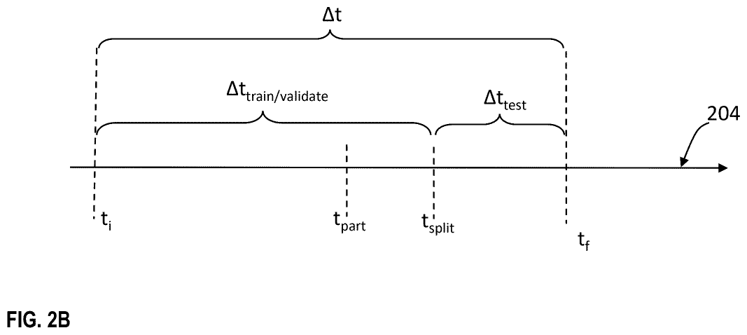

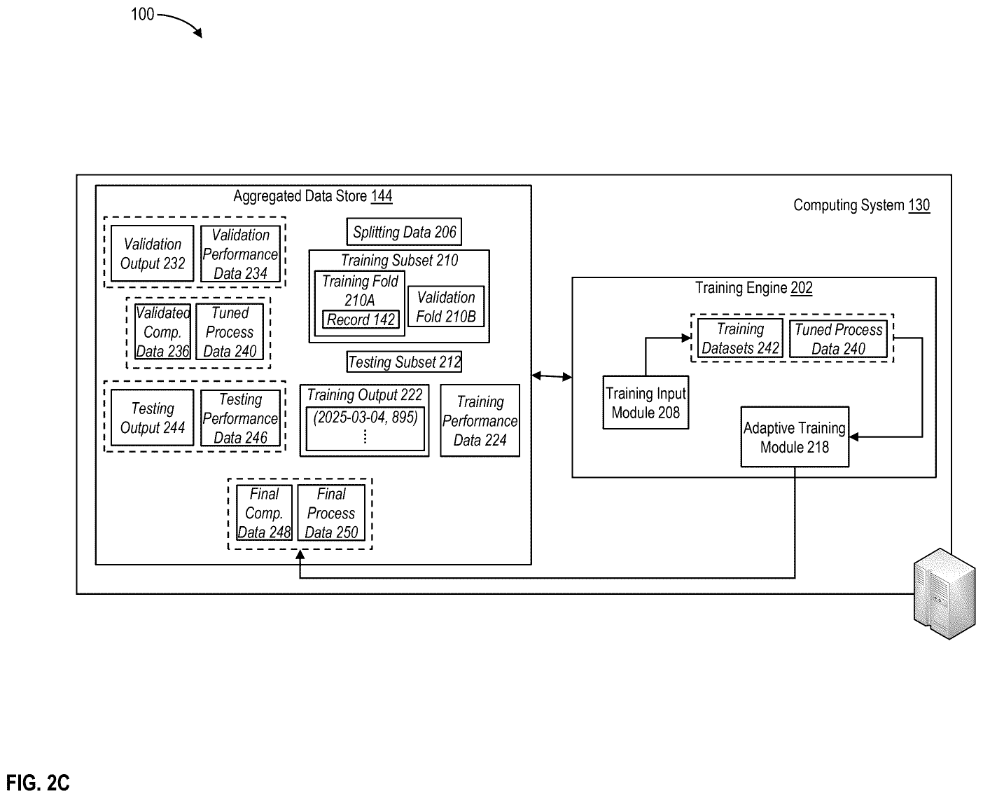

Referring to FIG. 2A, a training engine 202 executed by the one or more processors of computing system 130 may access portions of aggregated data records 142 maintained within aggregated data store 144, such as, but not limited to, data record 142A. As described herein, each of aggregated data records 142 may be associated with a corresponding business day within the one or more prior temporal intervals described herein, and each of aggregated data records 142 may include a temporal identifier of the corresponding business day, may identify and characterize, among other things, a number of initial submissions of applications adjudicated manually by the organization during the corresponding business day, a total number of applications (e.g., an initial submissions and resubmissions of applications) adjudicated manually by the organization during the corresponding business day, and may also include values of one or more external indicators during the corresponding business day. For example, data record 142A of aggregated data records 142 may include temporal data 146 that specifies the corresponding business day (e.g., Mar. 3, 2025), elements of unique manual adjudication data 150, which specify a number of initially submitted applications that were adjudicated manually by the organization on Mar. 3, 2025, elements of total manual adjudication data 158, which specify a total number of applications that were adjudicated manually by the organization on Mar. 3, 2025 (e.g., a sum of the initially submitted applications and the resubmitted application adjudicated on March 3^{rd}), and external indicator values 164, which includes values of one or more of the external indicators on Mar. 3, 2025, such as, but not limited to, the values of the housing starts, the household interest rate, the population, the number of residential sales on Mar. 3, 2025.

Executed training engine 202 may parse the accessed ones of aggregated data records 142, and based on corresponding ones of the temporal identifiers, determine that the accessed data records, and the corresponding, adjudicated application numbers, are characterized by decision dates disposed throughout a range of prior temporal intervals. In some instances, executed training engine 202 may perform operations that decompose the determined range of prior temporal intervals into a corresponding first subset of the prior temporal intervals (e.g., the “training” interval described herein), a corresponding second, subsequent, and disjoint subset of the prior temporal intervals (e.g., the in-time “validation” interval described herein), and a corresponding third, subsequent, and disjoint subset of the prior temporal intervals (e.g., the out-of-time “testing” interval described herein. For example, as illustrated in FIG. 2B, the range of prior temporal intervals (e.g., shown generally as Δₜ along timeline 204 of FIG. 2B) may be bounded by, and established by, temporal boundaries tᵢ and t_{f}. Further, the decomposed first subset of the prior temporal intervals (e.g., shown generally as an in-time training and validation interval Δt_{train/validate} along timeline 204 of FIG. 2B) may be bounded by temporal boundary tᵢ and a corresponding splitting point tₛₚₗᵢₜ along timeline 204, and the decomposed second subset of the prior temporal intervals (e.g., shown generally an out-of-time testing interval Δtₜₑₛₜ along timeline 204 of FIG. 2B) may be bounded by splitting point tₛₚₗᵢₜ and temporal boundary t_{f}.

Referring back to FIG. 2A, executed training engine 202 may generate elements of splitting data 206 that identify and characterize the determined temporal boundaries tᵢ and tr of the temporal data maintained within aggregated data store 144 and the range of prior temporal intervals established by the determined temporal boundaries Further, the elements of splitting data 206 may also identify and characterize the splitting point (e.g., the splitting point tₛₚₗᵢₜ described herein), the first subset of the prior temporal intervals (e.g., the in-time training and validation interval Δt_{train/validate} and corresponding boundaries described herein), and the second and subsequent subset of the prior temporal intervals (e.g., the out-of-time testing interval Δt_{testing} and corresponding boundaries described herein). As illustrated in FIG. 2A, executed training engine 202 may store the elements of splitting data 206 within the one or more tangible, non-transitory memories of computing system 130, e.g., within aggregated data store 144.

As described herein, each of aggregated data records 142 may be associated with a corresponding business day (e.g., a corresponding decision date) within one or more prior temporal intervals, and executed training engine 202 may perform operations that establish adaptively the splitting point between the corresponding temporal boundaries such that a first percentage of aggregated data records 142 characterize submitted applications having decision dates disposed within the in-time training and validation interval and such that a second percentage of aggregated data records 142 characterize submitted applications having decision dates disposed within the out-of-time testing interval. For example, the first percentage may correspond to approximately eighty percent of the data records and the second percentage may correspond to twenty percent of the data records, although in other examples, executed training engine 202 may compute one or more of the first and second percentages, and establish the decomposition point based on the range of prior temporal intervals, a number of discrete data records within aggregated data store 144, and/or a magnitude of the one or more prior temporal intervals.

In some examples, a training input module 208 of executed training engine 202 may access aggregated data records 142, e.g., as maintained in aggregated data store 144, and based on portions of splitting data 206, executed training input module 208 may perform operations that parse aggregated data records and determine that: (i) a subset 210 of aggregated data records 142 are associated with adjudicated applications having decisions dates disposed within the training and validation interval Δt_{train/validate}, and as such, may be appropriate to train adaptively and validate the time-series-based, hybrid neural-network process during the in-time training and validation interval Δt_{train/validate}, and (ii) a subset 212 of aggregated data records 142 are associated with applications having decisions dates disposed within the out-of-time testing interval Δtₜₑₛₜ, and as such, may be appropriate to testing the trained and validated time-series-based, hybrid neural-network process on previously unseen data prior to deployment.

Executed training input module 208 may also perform operations that decompose subset 210 into one or more partitions or folds that facilitate the adaptive training the time-series-based, hybrid neural-network process during the in-time training and validation interval Δt_{train/validate}, such as, but not limited to training fold 210A, and one or more partitions or folds that facilitate a validation of the trained time-series-based, hybrid neural-network process during the in-time training and validation interval Δt_{train/validate}, such as, but not limited to, validation fold 210B. In some instances, executed training input module 208 may perform operations that allocate the predetermined percentages of the data records of subset 210 to each of training fold 210A and validation fold 210B on a temporal basis. For example, executed training input module 208 may further partition Δt_{train/validate} at a corresponding temporal partition point tₚₐᵣₜ (e.g., as illustrated in FIG. 2B), and executed training input module 208 may perform operations that allocate those data records of subset 210 associated with business days (and characterizing applications having corresponding decision dates) disposed on or prior to tₚₐᵣₜ to training fold 210A, and that allocate those data records of subset 210 associated with business days (and characterizing applications having corresponding decision dates) disposed subsequent to tₚₐᵣₜ to validation fold 210B.

In other instances, executed training input module 208 may allocate equal portions of the data records of subset 210 to each of the training and validation partitions or folds (e.g., assign 50% of the data records of subset 210 to each of training fold 210A and validation fold 210B, assign 70% of the data records of subset 210 to training fold 210A and assign 30% of the data records of subset 210 validation fold 210B etc.). Further, in some example, executed training input module 208 may perform operations that apportion or assign pre-determined or unequal portions of the data records of subset 210 to each of the training and validation partitions or folds, and additionally, or alternatively, that apportion or assign the data records of subset 210 to corresponding ones of the training and validation partitions or folds in a manner that maintains a statistical character of the applications characterized of the assigned data records (e.g., in accordance with a corresponding apportionment schema).

Further, as illustrated in FIG. 2A, executed training input module 208 may perform operations that generate one of initial training datasets 214 associated with each, or a selected portion, of subset 210 of aggregated data records 142 allocated to training fold 210A. For example, each of initial training datasets 214 may include temporal data identifying a corresponding decision date disposed within in-time training and validation interval Δt_{train/validate}, an identifier of the target variable subject to prediction using the trained, time-series-based, hybrid neural-network process (e.g., the expected number of unique, initially submitted applications subject to manual adjudication by the organization on each day of the future temporal interval), and an incoming value of that target variable on the prediction date. Further, each of initial training datasets 214 may also include a plurality of candidate features, which may include, but are not limited to, all or a selected subset of the external indicator values maintained within the corresponding one of aggregated data records 142. For example, the values of the external indicators may include, but are not limited to, a total value of home sales in one or more jurisdictions (e.g., in thousands of dollars, etc.), an effective household interest rate and overnight interest rate (e.g., a percentage), housing starts in one or more jurisdictions (e.g., a six-month moving average of a monthly, seasonally adjusted annual rate, etc.), a population of one or more jurisdictions (e.g., in units of thousands), a bond yield (e.g., percentages for one-year, tow-year, etc.), gross domestic product in one or more jurisdictions, and measure of a core inflation rate (e.g., a CPI, etc.) at discrete intervals during the one or more prior temporal intervals.

By way of example, data record 142A associated with the Mar. 3, 2025, business day and decision date may be allocated to training fold 210A, and executed training input module 208 may perform operations, described herein, that generate a corresponding one of initial training datasets 214, such as training dataset 214A, that is associated with data record 142A. In some instances, training dataset 214A may include a plurality of discrete feature values (e.g., f₁, f₂, f₃, f₄, . . . , etc.), which may include, but are not limited to, temporal data that specifies the Mar. 3, 2025, decision date associated with data record 142A, the identifier of the target variable subject to prediction using the trained, time-series-based, hybrid neural-network process (e.g., the expected number of unique, initially submitted applications subject to manual adjudication by the organization on each day of the future temporal interval subsequent to the target date) and an incoming value of that target variable on the prediction date (e.g., the number of unique, initially submitted applications adjudicated manually by the organization on Mar. 3, 2025), and each, or a selected subset, of external indicator values 164 valid on March 3^{rd} decision data. Further, executed training input module 208 may also perform any of these exemplary processes to generate an additional one of training datasets based on additional, or alternate, ones of aggregated data records 142 allocated to training fold 210A.

Executed training input module 208 may also perform operations that generate initial process parameter values 216 for the time-series-based, hybrid neural-network process. For example, and as described herein, the time-series-based, hybrid neural-network process may include a NeuralProphet™ process that couples together a decomposable, time-series forecasting process with autoregression processing that leverages an auto-regressive neural network. The trained, auto-regressive neural network may, for example leverage a fast-feed, auto-regressive neural network, such as AR-Net™, and initial process parameter values 216 may include, but is not limited to, hyperparameters of the fast-feed, auto-regressive neural network, and the parameters of the decomposable, time-series forecasting process, e.g., the executable modules described herein that predict the trend, seasonal effects, effects due to events and holidays, and regression effects due to future-known exogenous variables, e.g., features. Initial process parameter values 216 may, in some instances, include one or more default values of the hyperparameters of the auto-regressive neural network and one or more default values of the parameters of the decomposable, time-series forecasting process. Additionally, or alternatively, initial process parameter values 216 may also include one or more values of the hyperparameters of the auto-regressive neural network and one or more values of the parameters of the executable modules of the decomposable, time-series forecasting process.

For example, the initial parameter values associated with the module of the time-series-based, hybrid neural-network process that predicts the trend across the future temporal interval may include, but are not limited to, an initial value of the offset m (i.e., the actual number of unique, initially submitted applications subject to manual adjudication by the organization at the temporal prediction point), an initial value of the growth rate k, and additionally, or alternatively, a number of changepoints, a value of a change point range, or a value of a trend regularization parameter. Further, the initial parameter values associated with the executable module of the time-series-based, hybrid neural-network process that predicts the effects of seasonality may include, but are not limited to, an initial model mode (e.g., multiplicative, etc.), an initial value of a daily, weekly, and/or yearly seasonality, and a value of a seasonality regularization parameter. In some instances, the initial parameter values of the executable module that predicts the effects of events and holidays during the future temporal interval may include, and leverage, one or more default events and holidays associated with the time-series-based, hybrid neural-network process, which may establish a binary variable for the default events and holidays, and the initial parameter values for the executable module that predicts the regression effects of future-known variables (e.g., features, etc.) may include one or more parameter values or thresholds that facilitates the execution of the least-squares process or other appropriate linear regression process described herein.

Further, by way of example, the initial hyperparameter values for the executable modules of the time-series-based, hybrid neural-network process that predict the regression effects of past observations and of lagged observations of variables (e.g., features, etc.) on the predicted value of the target variable future interval may include, but are not limited to, an order of the auto-regression (e.g., a number of lags that specifies the number of past observations subject to auto-regression, such as, but not limited to, fourteen days), an auto-regression regularization parameter that adjust a strength of a sparseness of the auto-regression, and additional hyperparameters that define a number of hidden layers and a number of neurons within the hidden layers of the auto-regression neural network. In some instances, initial process parameter values 216 may specify a value of zero for the number of hidden layers and the number of neurons of the auto-regressive neural network, which may establish a linear combination between the inputs to the auto-regressive neural network and the wights established during the exemplary training and validation processes described herein.

In some instances, initial process parameter values 216 may also include a value of one or more global parameters of the time-series-based, hybrid neural-network process. For example, these global parameter values may include, but are not limited to, data specifying a loss function, a learning rate of the time-series-based, hybrid neural-network process, a batch size and a number of epochs, and a number of forecasts within the predictive output of the time-series-based, hybrid neural-network process. The loss function may, for example, correspond to a mean application error (MAE), which measures a magnitude of a difference between the predicted number of unique, initially submitted applications subject to manual adjudication on each day of the future temporal interval and the actual number of unique, initially submitted applications that were adjudicated manually on each day of the future temporal interval. The disclosed embodiments are, however, not limited to loss functions that leverage MAE, and in other examples, the loss function may correspond to a mean absolute percentage error (MAPE) that measures a percentage error between the predicted number of unique, initially submitted applications subject to manual adjudication on each day of the future temporal interval and the actual number, or a mean absolute scaled error (MASE), which compares the predictive output of the time-series-based, hybrid neural-network process against naïve predictions, e.g., a MASE<1 would indicate that the time-series-based, hybrid neural-network process performs better on the prediction date that prior, naïve guesses from a prior temporal interval.

Referring back to FIG. 2A, training input module 208 may provide initial training datasets 214 (including training dataset 214A) and initial process parameter values 216 as inputs to an adaptive training module 218 of executed training engine 202. In some instances, and upon execution by the one or more processors of computing system 130, executed adaptive training module 218 may perform operations that adaptively train the time-series-based, hybrid neural-network process against the elements of training data included within each of initial training datasets 214, and in accordance with initial process parameter values 216. For example, and as described herein, computing system 130 may include one or more distributed components, and the distributed components of computing system 130 may execute adaptive training module 218 and may perform any of the exemplary processes described herein in parallel to train adaptively the time-series-based, hybrid neural-network process. The parallel implementation of adaptive training module 218 by the distributed components of computing system 130 may, in some instances, be based on an implementation, across the distributed components, of one or more of the parallelized, fault-tolerant distributed computing and analytical protocols described herein (e.g., the Apache Spark™ distributed, cluster-computing framework, etc.).

By way of example, and as described herein, the time-series-based, hybrid neural-network process may include a NeuralProphet™ process that couples together a decomposable, time-series forecasting process with autoregression processing that leverages an auto-regressive neural network, and executed adaptive training module 218 may perform operations that programmatically execute one or more executable modules that predict respective ones of the trend, seasonal effects, effects due to events and holidays, regression effects due to future-known exogenous variables (e.g., features), and the regression effects of past observations and of lagged observations of variables (e.g., features, etc.). For example, executed adaptive training module 218 may perform operations that execute programmatically a trend module 220A, a seasonality module 220B, an event module 220C, and a future regression module 220D. In some instances, executed trend module 220A may perform any of the exemplary processes described herein to compute, for each of training datasets 214 associated with a corresponding prediction date (e.g., a corresponding decision date), a value of the target variable (e.g., the expected number of unique, initially submitted applications subject to manual adjudication) on each day of the future, target temporal interval in accordance with initial process parameter values. Further, executed seasonality module 220B and executed event module 220C may also perform any of the exemplary processes described herein to determine, for each of training datasets 214 associated with the corresponding prediction date, a respective one of a predicted seasonality effect and a predicted effect of events on the predicted value of the target variable on each day of the future, target temporal interval in accordance with initial process parameter values.

Executed adaptive training module 218 may also perform operations that execute programmatically a future regression module 220D, which may perform any of the exemplary processes described herein to determine, for each of training datasets 214 associated with the corresponding prediction date, a regression effect of one or more of the specified features having known past and present values (e.g., one or more of the external indicator values described herein) on the predicted value of the target variable on each day of the future, target temporal interval in accordance with initial process parameter values 216. As described herein, executed future regression module 220D may determine the regression effect of these future-known features based on an application of a linear regression process to at least the past and future features.

Further, executed adaptive training module 218 may perform operations that execute programmatically an AR module 220E and a lagged AR module 220F. As described herein, each of executed AR module 220E and lagged AR module 220F may perform operations, described herein, that establish a plurality of nodes of an input layer of an auto-regressive neural network in accordance with process parameter values 216, and examples of the auto-regressive neural network may include, but are not limited to, a fast-feed neural network (e.g., the AR-Net™ associated with the NeuralProphet™ process). By way of example, the nodes of the auto-regressive neural network established by executed AR module 220E may ingest prior observations of the target variable (e.g., the actual number of unique, initially submitted applications adjudicated manually by the organization) at discrete temporal positions within a prior temporal interval, and the auto-regressive neural network may process the ingested data and generate, for each of training datasets 214 associated with the corresponding prediction date, a regression effect of these prior observations on the predicted value of the target variable on each day of the future, target temporal interval. As described herein, the number of discrete temporal positions may be indicated by the number of lags specified within initial process parameter values 216. In some instances, the discrete temporal positions may correspond to individual business days within a fourteen-day temporal interval prior to each of the corresponding prediction dates, and executed AR module 220E may obtain data specifying the prior observations of the target variable from corresponding ones of aggregated data records 142 (e.g., from unique manual adjudication data 150 associated with Mar. 3, 2024, as illustrated in FIG. 1).

Further, executed lagged AR module 22OF may also perform operations that identify one or more features within initial training datasets 214 that are associated with values during prior temporal intervals, but that lack values during the target, future temporal interval, and as such, that represent lagged features. In some instances, executed lagged AR module 220F may perform operations, described herein, that establish a plurality of nodes of an input layer of an auto-regressive neural network in accordance with process parameter values 216 for each of the identified lagged features, and the nodes of each of the auto-regressive neural networks established by executed lagged AR module 220F may ingest prior values of the corresponding lagged feature at discrete temporal positions within a prior temporal interval. Each of the auto-regressive neural networks established by executed lagged AR module 220F may process the ingested data and generate, for each of training datasets 214 associated with the corresponding prediction date, a regression effect of a corresponding of the prior values of a corresponding one of the lagged features on the predicted value of the target variable on each day of the future, target temporal interval. As described herein, the number of discrete temporal positions may be indicated by the number of lags specified within initial process parameter values 216. In some instances, the discrete temporal positions may correspond to individual business days within a fourteen-day temporal interval prior to each of the corresponding prediction dates, and executed lagged AR module 220F may obtain data specifying the prior values of each of the lagged features from corresponding ones of aggregated data records 142 (e.g., from external indicator values 164 associated with Mar. 3, 2024, as illustrated in FIG. 1).

For each of initial training datasets 214, each of executed trend module 220A, executed seasonality module 220B, executed event module 220C, executed future regression module 220D, executed AR module 220E, and executed lagged AR module 220F may generate a corresponding elements of output data (e.g., the trend and seasonality, event, and regression effects described herein) for each day of the future, target temporal interval. In some instances, and for each of training datasets 214, executed adaptive training module 218 may perform operations that compute a predicted value of the target variable (e.g., expected number of unique, initially submitted applications subject to manual adjudication by the organization) at each day of the future, target temporal interval as a sum the output values generated by executed trend module 220A, executed seasonality module 220B, executed event module 220C, executed future regression module 220D, executed AR module 220E, and executed lagged AR module 220F for that corresponding day. As illustrated in FIG. 2A, and for each of initial training datasets 214, executed adaptive training module 218 may associate each of the predicted values of the target variable with a temporal identifier of the corresponding day within the future, target temporal interval and may package the associated temporal identifiers and predicted values into a corresponding element of training output 222.

By way of example, and for training dataset 214A associated with the prediction date of Mar. 3, 2025, executed adaptive training module 218 may generate a corresponding element 222A of training output 222 that includes associated pairs of temporal identifiers and predicted values of the target variable during a twenty-eight-day period (e.g., the future, target temporal interval) ranging from Mar. 4, 2025, through Mar. 31, 2025. For instance, as illustrated in FIG. 2A, the time-series-based, hybrid neural-network process predicts initially that the organization will adjudicate manually 895 unique, initially submitted applications on Mar. 4, 2025. Further, although not illustrated in FIG. 2A, executed adaptive training module 218 may perform any of the exemplary processes described herein to generate an additional element of training output 222 for each additional, or alternate, one of initial training datasets 214.

Executed adaptive training module 218 may also compute, for each element of training output 222, a value of one or more metrics that characterize a performance or accuracy of the time-series-based, hybrid neural-network process during application to corresponding ones of initial training datasets 214. As described herein, each element of training output 222 includes associated pairs of temporal identifiers (e.g., identifying a specific day within the future, target temporal interval) and predicted values of the target variable on those specified days (e.g., the expected number of unique, initially submitted applications subject to manual adjudication by the organization). For each element of training output 222, executed adaptive training module 218 may access aggregated data records 142 maintained within aggregated data store 144 and may obtain the actual number of unique, initially submitted applications subject to adjudicate manually on each of the specified days (e.g., from unique manual adjudication data 150 in data record 142, etc.). Based on the predicted values and actual values of the target variable on each of the specified days, executed adaptive training module 218 may determine a value of the one or more metrics that characterize a performance or accuracy of time-series-based, hybrid neural-network process during application to each of initial training datasets 214. Examples of these one or more metrics may include, but are not limited to, the mean absolute error (MAE), the mean absolute percentage error (MAPE), and the mean absolute scaled error (MASE) described herein, and executed adaptive training module 218 may associate each of the computed metric values within a corresponding one of the elements of training output 222 and store the associated elements of training output 222 and the corresponding computed metric values within aggregated data store 144.

Further, and through the performance of these adaptive training processes, executed adaptive training module 218 may perform operations that iteratively add, subtract, or combine discrete features from initial training datasets 214. As described herein, each of initial training datasets 214 may also include a plurality of candidate features, which may include, but are not limited to, all or a selected subset of the external indicator values maintained within the corresponding one of aggregated data records 142. For example, the values of the external indicators may include, but are not limited to, a total value of home sales in one or more jurisdictions (e.g., in thousands of dollars, etc.), an effective household interest rate and overnight interest rate (e.g., a percentage), housing starts in one or more jurisdictions (e.g., a six-month moving average of a monthly, seasonally adjusted annual rate, etc.), a population of one or more jurisdictions (e.g., in units of thousands), a bond yield (e.g., percentages for one-year, tow-year, etc.), gross domestic product in one or more jurisdictions, and measure of a core inflation rate (e.g., a CPI, etc.) at discrete intervals during the one or more prior temporal intervals.

In some instances, executed adaptive training module 218 may perform operations that apply one or more statistical processes for corresponding portions of training output 222 and/or training performance data 224 to establish a degree of correlation between discrete pairs of these external indicators included as features within initial training datasets 214. For example, and based on the application of the statistical processes, executed adaptive training module 218 may determine a value of a Kendall rank correlation coefficient (e.g., a Kendall's t coefficient) for each of the external indicators included within initial training datasets 214 and subject to training using any of the exemplary processes described herein. The value of weighted Kendall rank correlation coefficient may range from zero to unity, with a value of zero indicative of a minimum correlation between values of a pair of external indicators in the prediction of the target variable during the future, target temporal interval, and with a value of unity indicative of a maximum correlation between the values of the pair of external indicator in the prediction of the target variable during the future, target temporal interval.

Further, executed adaptive training module 218 may parse the pairs of external indicator values and the corresponding values of Kendall rank correlation coefficient, and may identify at least a subset of the pairs of external indicator values associated with Kendall rank correlation coefficient values that exceed a predetermined or dynamically determined threshold value, such as, but not limited to, a threshold coefficient value of 0.6. The pairs of external indicators having Kendall rank correlation coefficient values that exceed the coefficient threshold value may be closely correlated during the training (and subsequent deployment) of the time-series-based, hybrid neural-network process, and certain of the highly correlated pairs of external indicators may provide redundant information in the prediction of the value of the target variable by time-series-based, hybrid neural-network process.

In some instances, for each highly correlated pair of external indicators, executed adaptive training module 218 may subtract one (or more) of the highly correlated external indicators from initial training datasets 214 and generate elements of modified composition data 226 that reflect the modification to the composition of initial training datasets 214. For example, modified composition data 226 may specify that an input dataset for the time-series-based, hybrid neural-network process may include temporal data that identifies a corresponding prediction date, an identifier of the target variable subject to prediction using the trained, time-series-based, hybrid neural-network process (e.g., the expected number of unique, initially submitted applications subject to manual adjudication by the organization on each day of the future temporal interval), an incoming value of that target variable on the prediction date, and values of a subset of the external indicators included within initial training datasets 214. The subset of the external indicators may, for example, be associated with Kendall rank correlation coefficient values that fall below the correlation threshold (and as such, are associated with values that are not highly corelated during the training (and subsequent deployment) of the time-series-based, hybrid neural-network process), and the subset of the external indicators may include, but is not limited to, the housing starts, the household interest rate, the population, the number of residential sales in one or more jurisdictions.

Executed adaptive training module 218 may also generate one or more modified process parameter values, which may include all or a selected subset of initial process parameter values 216, and which may also include values of one or more of the weights established during the implementation of the auto-regression neural networks (e.g., the fast-feed, auto-regression neural network described herein, etc.) by executed AR module 220E and additionally, or alternatively, by executed lagged AR module 220F. In some instances, executed adaptive training module 218 may package the modified process parameter values into corresponding portions of modified process data 228, and may perform operations that store the elements of modified composition data 226 and modified process data 228 within aggregated data store 144.

As illustrated in FIG. 2A, executed adaptive training module 218 may provide modified composition data 226 and modified process data 228 as inputs to executed training input module 208, which, in conjunction with executed adaptive training module 218, may perform operations that validate the trained time-series-based, hybrid neural-network process (e.g., the trained NeuralProphet™ process described herein) against data maintained within subset 210 of aggregated data records 142 allocated to validation fold 210B. For example, executed training input module 208 may receive modified composition data 226, and may perform any of the exemplary processes described herein to generate corresponding ones of validation datasets 230 associated with all, or a selected portion, the aggregated data records allocated to validation fold 210B. As described herein, a composition, and a sequential ordering, of features values within each of validation datasets 230 may be consistent with the composition and corresponding sequential ordering set forth in modified composition data 226. Examples of these feature values include, but are not limited to, one or more of the feature values extracted, obtained, computed, determined, or derived by executed training input module 208 and packaged into corresponding portions of initial training datasets 214.

Executed training input module 208 may provide the plurality of validation datasets 230 and modified process data 228 as inputs to executed adaptive training module 218, which may perform any of the exemplary processes described herein to validate the time-series-based, hybrid neural-network process against the elements of validation data included within each of validation datasets 230, and in accordance with the parameter values included within modified process data 228. For example, and as described herein, computing system 130 may include one or more distributed components, and the distributed components of computing system 130 may execute adaptive training module 218 and may perform any of the exemplary processes described herein in parallel to validate the trained time-series-based, hybrid neural-network process. The parallel implementation of adaptive training module 218 by the distributed components of computing system 130 may, in some instances, be based on an implementation, across the distributed components, of one or more of the parallelized, fault-tolerant distributed computing and analytical protocols described herein (e.g., the Apache Spark™ distributed, cluster-computing framework, etc.).

By way of example, and as described herein, the time-series-based, hybrid neural-network process may include a NeuralProphet™ process that couples together a decomposable, time-series forecasting process with autoregression processing that leverages an auto-regressive neural network, and executed adaptive training module 218 may perform any of the exemplary processes described herein to that programmatically execute each of trend module 220A, seasonality module 220B, event module 220C, future regression module 220D, AR module 220E, and lagged AR module 220F in accordance with the parameter values included within modified process data 228. Further, and for each of validation datasets 230, executed adaptive training module 218 may perform any of the exemplary processes described herein compute a predicted value of the target variable (e.g., expected number of unique, initially submitted applications subject to manual adjudication by the organization) at each day of the future, target temporal interval as a sum the output values generated by executed trend module 220A, executed seasonality module 220B, executed event module 220C, executed future regression module 220D, executed AR module 220E, and executed lagged AR module 220F for that corresponding day. As illustrated in FIG. 2A, and for each of validation datasets 230, executed adaptive training module 218 may associate each of the predicted values of the target variable with a temporal identifier of the corresponding day within the future, target temporal interval and may package the associated temporal identifiers and predicted values into a corresponding element of validation output data 232.

Executed adaptive training module 218 may also compute, for each element of validation output 232, a value of one or more metrics that characterize a performance or accuracy of the trained, time-series-based, hybrid neural-network process during validation against corresponding ones of validation datasets 230. As described herein, each element of validation output 232 includes associated pairs of temporal identifiers (e.g., identifying a specific day within the future, target temporal interval) and predicted values of the target variable on those specified days (e.g., the expected number of unique, initially submitted applications subject to manual adjudication by the organization). For each element of validation output 232, executed adaptive training module 218 may access aggregated data records 142 maintained within aggregated data store 144 and may obtain the actual number of unique, initially submitted applications subject to adjudicate manually on each of the specified days (e.g., from unique manual adjudication data 150 in data record 142, etc.). Based on the predicted values and actual values of the target variable on each of the specified days, executed adaptive training module 218 may determine a value of the one or more metrics that characterize a performance or accuracy of trained, time-series-based, hybrid neural-network process during application to each of validation datasets 230.

Examples of these one or more metrics may include, but are not limited to, the mean absolute error (MAE), the mean absolute percentage error (MAPE), and the mean absolute scaled error (MASE) described herein, and executed adaptive training module 218 may associate each of the computed metric values within a corresponding one of the elements of validation output 232 and store the associated elements of validation output 232 and the corresponding computed metric values within aggregated data store 144. The disclosed embodiments are, however, not limited to these exemplary computed metric values, and in other instances, executed adaptive training module 218 may compute a value of any additional, or alternate, metric appropriate to validation datasets 230, validation output 232, or the trained, time-series-based, hybrid neural-network process.

In some examples, executed adaptive training module 218 may also perform operations that determine whether all, or a selected portion of, the computed metric values satisfy one or more threshold validation conditions. For instance, the threshold validation conditions may specify one or more predetermined threshold values for the trained, time-series-based, hybrid neural-network, such as, but not limited to, predetermined threshold values for the computed MAE values, the computed MAPE values, and/or the computed MASE values. In some examples, executed adaptive training module 218 that establish whether one, or more, of the computed MAE values, the computed MAPE values, and/or the computed MASE values exceed, or fall below, a corresponding one of the predetermined threshold values and as such, whether the performance or accuracy of the trained, time-series-based, hybrid neural-network satisfies the threshold validation conditions.

If, for example, executed adaptive training module 218 were to establish that one, or more, of the computed metric values fail to satisfy at least one of the threshold validation conditions, computing system 130 may establish that the adaptively trained, gradient-boosted, decision-tree process is insufficiently accurate for a real-time application to the elements of confidential data described herein. Executed adaptive training module 218 may perform operations (not illustrated in FIG. 2A) that transmit data indicative of the established inaccuracy to executed training input module 208, which may perform any of the exemplary processes described herein to generate one or more additional training datasets, which may be provisioned to executed adaptive training module 218. In some instances, executed adaptive training module 218 may receive the additional training datasets, and may perform any of the exemplary processes described herein to train further the time-series-based, hybrid neural-network against the elements of training data included within each of the additional training datasets.

Alternatively, if executed adaptive training module 218 were to establish that each computed metric value satisfies the threshold validation conditions, executed adaptive training module 218 may deem the trained, time-series-based, hybrid neural-network successfully validated, and may generate elements of validated composition data 236, which characterizes a composition of an input dataset for the adaptively trained, and now validated, time-series-based, hybrid neural-network process (e.g., the NeuralProphet™ process, described herein) and identifies each of the discrete feature within the input dataset, along with a sequence or position of these feature within the input dataset.

Executed adaptive training module 218 may perform one or more processes that adaptively or dynamically tune one or more of the parameters of the decomposable, time-series forecasting process of the time-series-based, hybrid neural-network process, and one or more of the hyperparameters of the auto-regressive neural network associated with the time-series-based, hybrid neural-network process, based on data characterizing the initial training and subsequent validation of the time-series-based, hybrid neural-network process. For example, a tuning module 238 of executed adaptive training module 218 may obtain, from aggregated data store 144, initial process parameter values 216, which specifies the parameters of the decomposable, time-series forecasting process and the hyperparameters of the auto-regressive neural network during the initial training of the time-series-based, hybrid neural-network process, and modified process data 228, which specifies the parameters of the decomposable, time-series forecasting process and the hyperparameters of the auto-regressive neural network during the validation of the time-series-based, hybrid neural-network process. Executed tuning module 238 may also obtain from aggregated data store 144, training output 222 and validation output 232, and elements of training performance data 224 and validation performance data 234.

In some instances, based on initial process parameter values 216 and modified process data 228, and on the elements of training output 222, training performance data 224, validation output 232, and validation performance data 234, executed tuning module 238 may perform a Bayesian optimization process, such as an Optuna™ optimization process, that tunes the parameters of the decomposable, time-series forecasting process and the hyperparameters of the auto-regressive neural network. In some instances, when implemented by executed tuning module 238, the Bayesian optimization process (e.g., the Optuna™ optimization process) may leverage reinforcement learning processes to select optimal values of each, or a subset, of the parameters of the decomposable, time-series forecasting process and the hyperparameters of the auto-regressive neural network that result in a minimum error in the prediction of the value of the target variable during the future, target temporal interval via the time-series-based, hybrid neural-network process (e.g., by selecting values of the parameters and hyperparameters that result in a minimal MAE value, etc.). Executed tuning module 238 may package the tuned values of the parameters of the decomposable, time-series forecasting process and the hyperparameters of the auto-regressive neural network (e.g., an output of the Bayesian optimization process) into a corresponding portion of tuned process data 240, and executed adaptive training module 218 may perform operations that store the elements of validated composition data 236 and tuned process data 240 within aggregated data store 144.

Referring to FIG. 2C, executed adaptive training module 218 may perform operations that further characterize an accuracy, and a performance, of the adaptively trained, and now validated, time-series-based, hybrid neural-network process (e.g., the NeuralProphet™ process described herein) against elements of testing data associated with out-of-time testing interval Δt_{testing} (e.g., along timeline 204 of FIG. 2B) and maintained within testing subset 212 of aggregated data records 142. In some instances, the further testing of the adaptively trained, and now validated, time-series-based, hybrid neural-network process against the elements of temporally distinct testing data may confirm a predictive capability of the adaptively trained and validated, time-series-based, hybrid neural-network process using previously unseen data, and may further establish the readiness of the adaptively trained and validated, time-series-based, hybrid neural-network process for deployment and real-time application to the elements of confidential data described herein.

For example, executed training input module 208 may obtain validated composition data 236 from aggregated data store 144, and may perform any of the exemplary processes described herein to generate corresponding ones of testing datasets 242 associated with all, or a selected portion, the aggregated data records allocated to testing subset 212. As described herein, a composition, and a sequential ordering, of features values within each of testing datasets 242 may be consistent with the composition and corresponding sequential ordering set forth in validated composition data 236. Examples of these feature values include, but are not limited to, one or more of the feature values extracted, obtained, computed, determined, or derived by executed training input module 208 and packaged into corresponding portions of initial training datasets 214 and validation datasets 230.

Executed training input module 208 may provide the plurality of testing datasets 242 and tuned process data 240 as inputs to executed adaptive training module 218, which may perform any of the exemplary processes described herein to test the trained and validated time-series-based, hybrid neural-network process against the elements of out-of-time testing data included within each of testing datasets 242, and in accordance with the parameter and hyperparameter values included within tuned process data 240. For example, and as described herein, computing system 130 may include one or more distributed components, and the distributed components of computing system 130 may execute adaptive training module 218 and may perform any of the exemplary processes described herein in parallel to validate the trained time-series-based, hybrid neural-network process. The parallel implementation of adaptive training module 218 by the distributed components of computing system 130 may, in some instances, be based on an implementation, across the distributed components, of one or more of the parallelized, fault-tolerant distributed computing and analytical protocols described herein (e.g., the Apache Spark™ distributed, cluster-computing framework, etc.).

By way of example, and as described herein, the time-series-based, hybrid neural-network process may include a NeuralProphet™ process that couples together a decomposable, time-series forecasting process with autoregression processing that leverages an auto-regressive neural network, and executed adaptive training module 218 may perform any of the exemplary processes described herein to that programmatically execute each of trend module 220A, seasonality module 220B, event module 220C, future regression module 220D, AR module 220E, and lagged AR module 220F in accordance with the parameter values included within modified process data 228. Further, and for each of testing datasets 242 associated with a corresponding prediction date, executed adaptive training module 218 may perform any of the exemplary processes described herein compute a predicted value of the target variable (e.g., expected number of unique, initially submitted applications subject to manual adjudication by the organization) at each day of the future, target temporal interval as a sum the output values generated by executed trend module 220A, executed seasonality module 220B, executed event module 220C, executed future regression module 220D, executed AR module 220E, and executed lagged AR module 220F for that corresponding day. As illustrated in FIG. 2C, and for each of testing datasets 242, executed adaptive training module 218 may associate each of the predicted values of the target variable with a temporal identifier of the corresponding day within the future, target temporal interval and may package the associated temporal identifiers and predicted values into a corresponding element of testing output 244.

Executed adaptive training module 218 may also compute, for each element of testing output 244, a value of one or more metrics that characterize a performance or accuracy of the trained, time-series-based, hybrid neural-network process during testing against corresponding ones of testing datasets 242. As described herein, each element of testing output 244 includes associated pairs of temporal identifiers (e.g., identifying a specific day within the future, target temporal interval) and predicted values of the target variable on those specified days (e.g., the expected number of unique, initially submitted applications subject to manual adjudication by the organization). For each element of testing output 244, executed adaptive training module 218 may access aggregated data records 142 maintained within aggregated data store 144 and may obtain the actual number of unique, initially submitted applications subject to adjudicate manually on each of the specified days (e.g., from unique manual adjudication data 150 of data record 142, etc.). Based on the predicted values and actual values of the target variable on each of the specified days, executed adaptive training module 218 may determine a value of the one or more metrics that characterize a performance or accuracy of trained and validated, time-series-based, hybrid neural-network process during application to each of testing datasets 242.

Examples of these one or more metrics may include, but are not limited to, the mean absolute error (MAE), the mean absolute percentage error (MAPE), and the mean absolute scaled error (MASE) described herein, and executed adaptive training module 218 may package the each of the computed metric values into a corresponding portion of testing performance data 246. Executed adaptive training module 218 may also associate each of the computed metric values within a corresponding one of the elements of testing output 244 and store the associated elements of testing output 244 and testing performance data 246 within aggregated data store 144. The disclosed embodiments are, however, not limited to these exemplary computed metric values, and in other instances, executed adaptive training module 218 may compute a value of any additional, or alternate, metric appropriate to testing datasets 242, testing output 244, or the trained, time-series-based, hybrid neural-network process.

In some examples, executed adaptive training module 218 may also perform operations that determine whether all, or a selected portion of, the computed metric values satisfy one or more threshold validation conditions. As described herein, the threshold validation conditions may specify one or more predetermined threshold values for the trained, time-series-based, hybrid neural-network, such as, but not limited to, predetermined threshold values for the computed MAE values, the computed MAPE values, and/or the computed MASE values. In some examples, executed adaptive training module 218 that establish whether one, or more, of the computed MAE values, the computed MAPE values, and/or the computed MASE values exceed, or fall below, a corresponding one of the predetermined threshold values and as such, whether the performance or accuracy of the trained and validated, time-series-based, hybrid neural-network process satisfies the threshold validation conditions.

If, for example, executed adaptive training module 218 were to establish that one, or more, of the computed metric values fail to satisfy at least one of the threshold validation conditions, computing system 130 may establish that the adaptively trained, and validated, time-series-based, hybrid neural-network process is insufficiently accurate for a real-time application to the elements of confidential data described herein. Executed adaptive training module 218 may perform operations (not illustrated in FIG. 2C) that transmit data indicative of the established inaccuracy to executed training input module 208, which may perform any of the exemplary processes described herein to generate one or more additional training datasets, which may be provisioned to executed adaptive training module 218. In some instances, executed adaptive training module 218 may receive the additional training datasets, and may perform any of the exemplary processes described herein to train further the time-series-based, hybrid neural-network process against the elements of training data included within each of the additional training datasets.

Alternatively, if executed adaptive training module 218 were to establish that each computed metric value satisfies the threshold validation conditions, executed adaptive training module 218 may deem the trained and validated, time-series-based, hybrid neural-network ready for deployment, and may generate elements of final composition data 248, which characterizes a composition of an input dataset for the adaptively trained, and now validated, time-series-based, hybrid neural-network process (e.g., the NeuralProphet™ process, described herein) and identifies each of the discrete feature within the input dataset, along with a sequence or position of these feature within the input dataset. Executed adaptive training module 218 may also package the values of the parameters and hyperparameters of the adaptively trained, and now validated, time-series-based, hybrid neural-network process (e.g., within tuned process data 240) into corresponding portions of final process data 250 and executed adaptive training module 218 may store final composition data 248 and final process data 250 within aggregated data store 144.

Further although not illustrated in FIG. 2C, computing system 130 may continue to monitor a performance and an accuracy of the time-series-based, hybrid neural-network process subsequent to its deployment and ingestion of elements of confidential data maintained within the organization. For example, computing system 130 may monitor one or more of the metric values characterizing the performance or accuracy of the time-series-based, hybrid neural-network process on a weekly, monthly, or quarterly basis subsequent to deployment, and should one or more of these metric values fall below a corresponding threshold value, computing system 130 may perform operations that initiate a retraining of the time-series-based, hybrid neural-network process using any of the exemplary processes described herein.

In other examples, the successful training and validation of the time-series-based, hybrid neural-network process may be associated with a corresponding period of validity that, once expired, triggers a retraining of the time-series-based, hybrid neural-network process by computing system 130 using any of the exemplary processes described herein. By way of example, the corresponding period of validity may include a two-week period, and upon expiration of this initial, two-week period, computing system 130 may perform any of the exemplary processes to training further the time-series-based, hybrid neural-network process using additional training, validation, and testing datasets that include elements of newly ingested, and aggregated, data maintained within aggregated data records 142.

In some instances, described herein, a time-series-based, hybrid neural-network process may be trained to predict, at a temporal prediction point, an expected number of unique, initially submitted applications subject to manual adjudication by an organization on each day of a future temporal interval, such as, but not limited to, a twenty-eight day period subsequent to the temporal prediction point. For example, and based on an application of the trained, time-series-based, hybrid neural-network process to an input dataset associated with a corresponding prediction date, the one or more distributed components of computing system 130 may generate elements of output data indicative of an expected number of unique, initially submitted applications subject to manual adjudication by an organization on each day of a future temporal interval. Each of the generated elements of output data may be associated with a corresponding day within the future, target temporal interval, and may associate together a temporal identifier of that corresponding day (e.g., an alphanumeric text string, etc.) and a numerical value of the expected number of unique, initially submitted applications subject to manual adjudication on the corresponding day). Further, computing system 130 may perform any of the exemplary processes described herein to apply the trained, time-series-based, hybrid neural-network process to the input dataset in accordance with a predetermined schedule, e.g., on a biweekly basis, etc., or based on a request generated programmatically by one or more application programs executed by an adjudication system.

By way of example, an initial, unique submission of an application for an available product or service may, in some instances, be approved immediately by the organization using any of the programmatic or manual processes described herein. In other instances, an eventual approval of the application for the available product or service may require multiple resubmissions of the application in response to corresponding, and negative, decisions rendered by the organization. For example, the organization may reject manually the initial application due to a lack of appropriate documentation, and a corresponding customer of the organization may resubmit the application for the with additional, or alternate, documentation that addresses the prior rejection. In some instances, and due to the likelihood of potential, multiple resubmissions of applications by customers of the organization, the expected number of unique, initially submitted applications subject to manual adjudication predicted by the trained, time-series-based, hybrid neural-network process may not accurately reflect a total number of applications subject to manual adjudication on one or more of the days within the future, target temporal interval.

In some instances, to account for the likely resubmission of applications within the future temporal interval, computing system 130 may also perform any of the exemplary processes described herein to apply a multiplier-based extrapolation process to the output of the trained time-series-based, hybrid neural-network process (e.g., the expected number of unique, initially submitted applications subject to manual adjudication by the organization on each day of the future temporal interval), and based on the application of the multiplier-based extrapolation process to the expected number of unique, initially submitted applications subject to manual adjudication by the organization on each day of the future temporal interval, computing system 130 may predict an expected, total number of submitted applications subject to manual adjudication by the organization on each day of the future temporal interval. The total number of submitted applications may represent a sum of the expected number of the unique, initially submitted applications and an expected number of resubmitted applications, and as described herein, the multiplier-based extrapolation process may apply a proxy multiplier to the expected number predicted by the trained time-series-based, hybrid neural-network process. The additional output data generated by the multiplier-based extrapolation process, which includes the total number of submitted applications subject to manual adjudication by the organization on each day of the future temporal interval, may enable one or more computing systems of an adjudication system to not only allocate or reallocate physical resources to facilitate the expected daily number of applications subject to manual adjudication, but also to allocate, or reallocate, computation resources within the adjudication system that facilitate and support the manual adjudication of these initial and resubmitted applications.

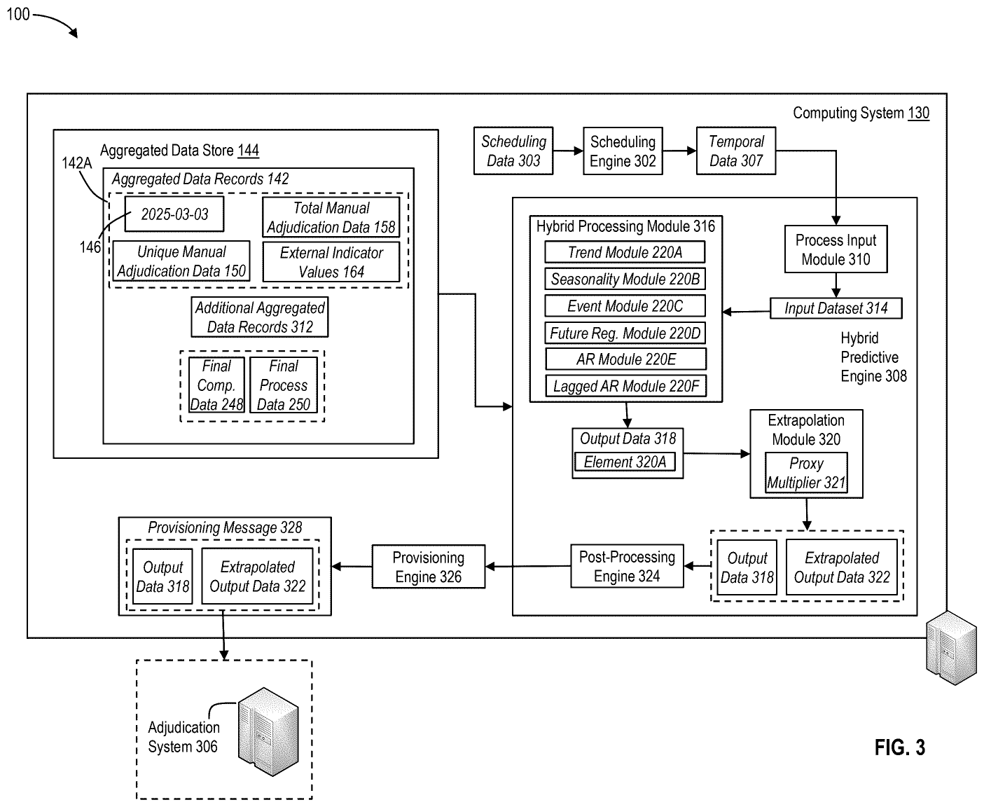

Referring to FIG. 3, a scheduling engine 302 executed by the one or more processors of computing system 130 (e.g., by one or more of the distributed components of computing system 130) may access elements of schedule data 303, which may be maintained within the tangible, non-transitory memories of computing system 130. Executed scheduling engine 302 may parse scheduling data 304 and may determine that computing system 130 is scheduled to provision, to an adjudication system 306 associated with, or operated by, the organization on Mar. 3, 2025 (e.g., a prediction date), data characterizing a total number of submitted applications subject to manual adjudication by adjudication system 306 on each day of the future temporal interval extending from Mar. 4, 2025, through Mar. 31, 2025. Based on the determination, executed scheduling engine 302 may perform operations that cause the one or more processors of computing system 130 to execute a hybrid prediction engine 308, which may facilitate an application of the trained, time-series-based, hybrid neural-network process to an input dataset associated with the Mar. 3, 2025, prediction date, and an application of the multiplier-based extrapolation process to an output of the trained time-series-based, hybrid neural-network process on the Mar. 3, 2025, prediction date.

In some instances, executed scheduling engine 302 may provision elements of temporal data 307, which indicates the prediction date of Mar. 3, 2025, to executed hybrid prediction engine 308. A process input module 310 of executed hybrid predictive engine 308 may receive temporal data 307, which specifies the Mar. 3, 2025, prediction date, and executed process input module 310 may access aggregated data store 144 and obtain a corresponding one of the aggregated data records associated with, and referencing, the Mar. 3, 2025, prediction date, e.g., data record 142A. As described herein, data record 142 may include temporal data 146, which identifies the March 3^{rd} prediction date, elements of unique manual adjudication data 150, which specify a total number of initially submitted applications manually adjudication on Mar. 3, 2025, elements of total manual adjudication data 158, which specify a total number of applications that were adjudicated manually by the organization on Mar. 3, 2025 (e.g., including both initially submitted applications and resubmitted applications), and elements of external indicator values 164, which include values of one or more of the external indicators on Mar. 3, 2025, such as, but not limited to, the values of the housing starts, the household interest rate, the population, the number of residential sales on Mar. 3, 2025.

Further, executed process input module 310 may perform operations that obtain, from aggregated data store 144, elements of final composition data 248 that characterize a composition of an input dataset for the trained, and validated time-series-based, hybrid neural-network process (e.g., the adaptively trained, and validated, NeuralProphet™ process described herein) and identify each of the discrete feature values within the input dataset, along with a sequence or position of these feature values within the input dataset. By way of example, executed process input module 310 may perform operations, described herein, that obtain or extract one or more of the input features values specified within the elements of final composition data 248 from corresponding portions of data records 142 associated with the March 3^{rd} prediction date.

As described herein, the elements of final composition data 248 may indicate that the input dataset includes, but is not limited to, temporal data that identifies the March 3^{rd} prediction date, an identifier of the target variable subject to prediction using the trained, time-series-based, hybrid neural-network process (e.g., the expected number of unique, initially submitted applications subject to manual adjudication by the organization on each day of the future temporal interval), an incoming value of that target variable on the March 3^{rd} prediction date, and one or more values of external indicators, such as, but not limited to, housing starts, household interest rate, population, number of residential sales in one or more jurisdictions. In some instances, executed process input module 310 may generate the identifier of the target variable, and may obtain, from data record 142, the data identifying the March 3^{rd} prediction date (e.g., from temporal data 146), the incoming value of that target variable (e.g., from unique manual adjudication data 150), and the one or more values of the external indicators (e.g., from external indicator values 164).

Executed process input module 310 may perform operations that package each of the obtained and generated feature values (e.g., the temporal data, the identifier of the target variable, the incoming value of that target variable, and the one or more external indicator values) into corresponding portions of an input dataset 314 in accordance with the respective positions specified within the elements of final composition data 248. Executed process input module 310 may also provision input dataset 314 as an input to a hybrid processing module 316 of executed hybrid predictive engine 308, and executed hybrid processing module 316 may perform operations that obtain, from aggregated data store 144, elements of final process data 250 that includes the value of the one or more of the parameters of the decomposable, time-series forecasting process of the trained, time-series-based, hybrid neural-network process, and the value of the one or more of the hyperparameters of the auto-regressive neural network associated with the trained, time-series-based, hybrid neural-network process, such as, but not limited to, those parameters and hyperparameters described herein.

Executed hybrid processing module 316 may perform operations that apply the trained, time-series-based, hybrid neural-network process to the feature values within input dataset 314 in accordance with the parameter values and the hyperparameter values within final process data 250. Further, and based on the application of the trained, time-series-based, hybrid neural-network process to the feature values, executed hybrid processing module 316 may generate elements of output data 318 indicative of the expected number of unique, initially submitted applications subject to manual adjudication by the organization on each day of the future temporal interval.

As described herein, the trained, time-series-based, hybrid neural-network process may include a NeuralProphet™ process that couples together a decomposable, time-series forecasting process with autoregression processing that leverages an auto-regressive neural network, and executed hybrid processing module 316 may perform any of the exemplary processes described herein to that programmatically execute each of trend module 220A, seasonality module 220B, event module 220C, future regression module 220D, AR module 220E, and lagged AR module 220F in accordance with the parameter values and hyperparameters included within final process data 250. Further, for input dataset 314 associated with the March 3^{rd} prediction date, executed hybrid processing module 316 may perform any of the exemplary processes described herein compute a predicted value of the target variable (e.g., expected number of unique, initially submitted applications subject to manual adjudication by the organization) at each day of the future, target temporal interval as a sum the output values generated by executed trend module 220A, executed seasonality module 220B, executed event module 220C, executed future regression module 220D, executed AR module 220E, and executed lagged AR module 220F for that corresponding day. Executed hybrid processing module 316 may also associate each of the predicted values of the target variable with a temporal identifier of the corresponding day within the future, target temporal interval and may package the associated temporal identifiers and predicted values into a corresponding element of output data 318.

For example, the future, target temporal interval may correspond to a twenty-eight-day interval subsequent to the March 3^{rd} prediction date, and may include a temporal interval from Mar. 4, 2025, through Mar. 31, 2025. In some instances, output data 318 may include a discrete element associated with each day within the twenty-eight-day interval, and each of the discrete elements may associate a temporal identifier of the corresponding day with the expected number of unique, initially submitted applications subject to manual adjudication by the organization on the corresponding day. For example, as illustrated in FIG. 3, output data 318 may include a discrete element 320A with Mar. 4, 2025, which includes an identifier of the corresponding day (e.g., “2025 Mar. 4”) and the expected number of unique, initially submitted applications subject to manual adjudication on Mar. 4, 2025 (e.g., “875” applications). Further, although not illustrated in FIG. 3, output data 318 may include an additional element associated with each additional day within the twenty-eight-day, e.g., each day between from March 5th and March 31^{st}.

Executed hybrid processing module 316 may provision the elements of output data 318 as an input to an extrapolation module 320 of executed hybrid prediction engine 308, which perform any of the exemplary processes described herein to apply the multiplier-based extrapolation process to the output of the trained time-series-based, hybrid neural-network process and to generate, for each day within the target, future temporal interval, an extrapolated value representative of the expected, total number of all submitted applications (e.g., initial submissions and resubmissions) subject to manual adjudication by the organization on each day of the future temporal interval. As described herein, extrapolation module 320 may perform operations, consistent with the multiplier-based extrapolation process, that compute a proxy multiplier as a rolling average of a ratio between a total number of applications adjudicated manually by the organization and a number of the initially submitted applications adjudicated manually by the organization on each day of a prior temporal interval, and that compute the extrapolated value representative of the expected, total number of all submitted applications subject to manual adjudication on each day of the future temporal interval as a product of the proxy multiplier and the predicted value of the target variable on each day of the future temporal interval, e.g., as maintained within the elements of output data 318.

For example, the prior temporal interval may correspond to a fourteen-day-interval that extends from Feb. 18, 2025, through and including Mar. 3, 2025. In some instances, executed extrapolation module 320 may access aggregated data store 144 and obtain a subset of aggregated data records 142 that are associated with, or that reference, dates within the two-week prior interval of the March 3^{rd} prediction date (e.g., between Feb. 18, 2025, and Mar. 3, 2025). As illustrated in FIG. 3, the subset may include data record 142A associated with Mar. 3, 2025, and additional data records 312 associated with respective dates between February 18^{th} and March 2^{nd}, and executed extrapolation engine may extract the total number of applications adjudicated manually by the organization and the value of initially submitted applications adjudicated manually by the organization from data record 142A (e.g., from total manual adjudication data 158 and from unique manual adjudication data 150, respectively), and from each of additional data records 312.

Further, executed extrapolation module 320 may compute the ratio of the total number of applications adjudicated manually and a number of the initially submitted applications adjudicated manually on each day in the prior temporal interval (e.g., from February 18^{th} to March 3^{rd}), and may compute a rolling average of the fourteen computed ratio using any of the exemplary processes described herein. As described herein, the computed rolling average may represent a proxy multiplier 321 within the multiplier-based extrapolation process, and executed extrapolation module 320 may multiply the value of the expected number of unique, initially submitted applications subject to manual adjudication by the organization within each element of output data 318 by the proxy multiplier, and package the product of proxy multiplier 321 and the expected number associated with each element of output data 318 into a corresponding element of extrapolated output data 322. As described herein, each element of extrapolated output data 322 associates the identifier of the corresponding day within the future temporal interval with the corresponding, computed extrapolated value, which represents the expected total number of all submitted applications (e.g., initial submissions and resubmissions) subject to manual adjudication by the organization on the corresponding day of the future temporal interval.

In some instances, executed extrapolation module 320 may provide both the elements of output data 318, which specify the expected number of unique, initially submitted applications subject to manual adjudication by the organization on each day of the future, target temporal interval, and the elements of extrapolated output data 322, which specify the expected total number of all submitted applications (e.g., initial submissions and resubmissions) subject to manual adjudication by the organization on each day of the future temporal interval, as inputs to a post-processing module 324 of executed hybrid predictive engine 308, which may apply one or more post-processing operations to the elements of output data 318 and extrapolated output data 322. For example, executed post-processing module 324 may identify one or more of the elements of output data 318, or of extrapolated output data 322, that are associated with a weekend or a holiday, executed post-processing module 324 may perform operations that adjust any expected number associated with the weekend or the holiday to an immediately prior business day (e.g., expected number on a Saturday may added to the expected number on a prior Friday) or to an immediately subsequent business day (e.g., expected number on a Sunday may added to the expected number on a subsequent Monday).

As illustrated in FIG. 3, executed hybrid predictive engine 308 may provide the post-processed elements of output data 318 and of extrapolated output data 322 as inputs to a provisioning engine 326 executed by the one or more processors of computing system 130. Executed provisioning engine may package the post-processed elements of output data 318 and of extrapolated output data 322 into corresponding portions of a provisioning message 328, which computing system 130 may transmit across network 120 to an adjudication system 306 associated with the organization and with the programmatic, or manual, approval of the applications for the available products or services. In some instances, one or more processors of adjudication system 306 may execute one or more application programs that cause adjudication system 306 to receive provisioning message 328, to obtain the elements of output data 318, which specify the expected number of unique, initially submitted applications subject to manual adjudication by the organization on each day of the future, target temporal interval from March 4^{th} to March 31^{st}, and the elements of extrapolated output data 322, which specify the expected total number of all submitted applications (e.g., initial submissions and resubmissions) subject to manual adjudication by the organization on each day of the future temporal interval from March 4^{th} to March 31^{st} Further, although not illustrated in FIG. 3, adjudication system 306 may perform operations, described herein, that allocate, or modify a prior allocation of, physical or computational resources to address the expected number of initially submitted applications, and the expected number of all applications, subject to manual adjudication on a daily basis between March 4^{th} and March 31^{st}.

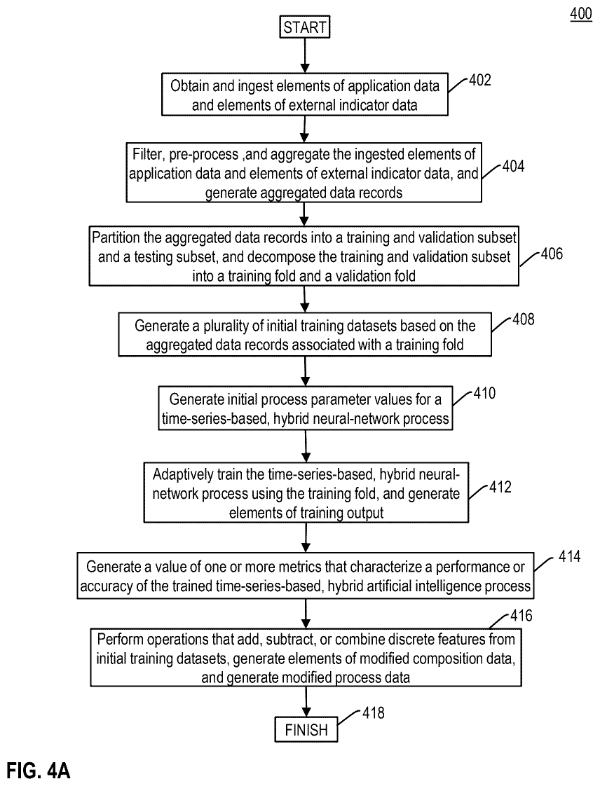

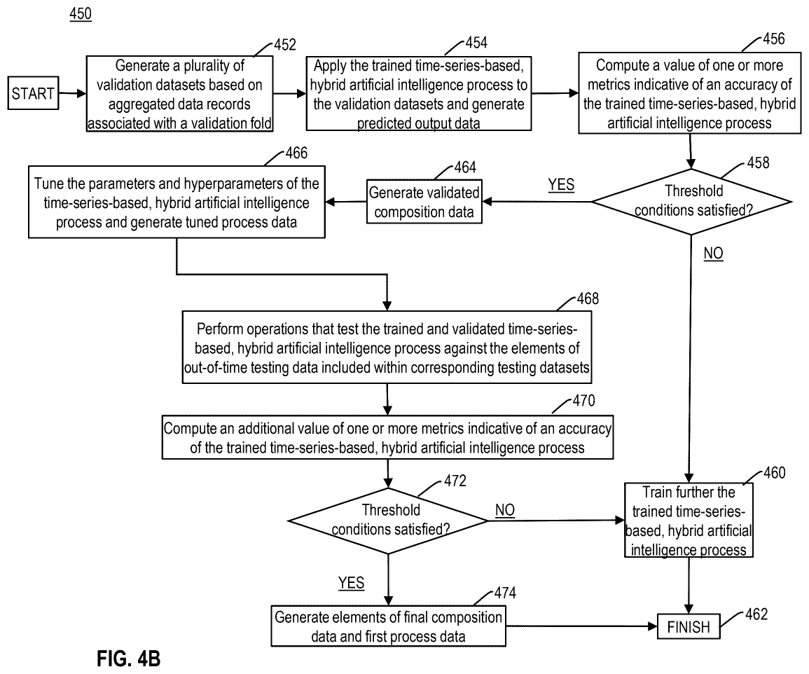

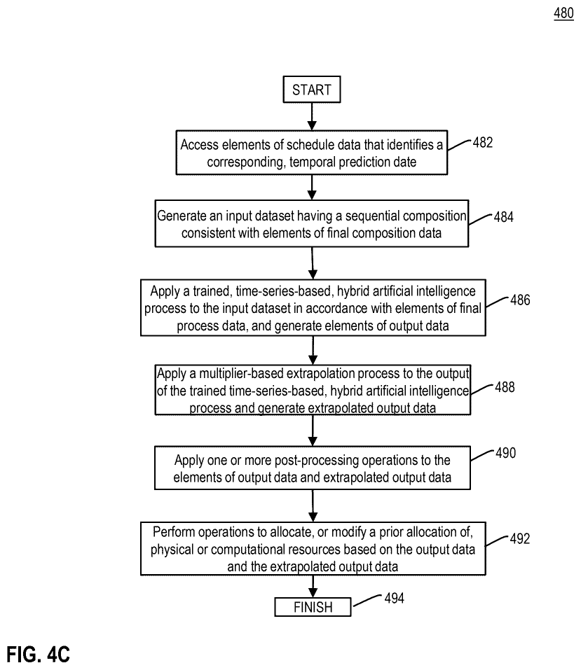

FIGS. 4A and 4B are flowcharts of exemplary processes for adaptively training, validating, and testing hybrid, time-series-based, artificial intelligence processes in distributed computing environments, in accordance with some examples. As described herein, the hybrid, time-series-based, artificial intelligence process may include a time-series-based, hybrid neural-network process (e.g., a NeuralProphet™ process) that couples together a decomposable, time-series forecasting process within autoregression processing that leverages an auto-regressive neural network. Further, one or more of the exemplary processes described herein may utilize partitioned training and validations datasets associated with a first prior temporal interval (e.g., an in-time training interval), and testing datasets associated with a second, and distinct, prior temporal interval (e.g., an out-of-time testing interval). In some instances, or more computing systems, such as, but not limited to, one or more of the distributed components of computing system 130, may perform one or more of the steps of exemplary process 400 illustrated in FIG. 4A and the one or more of the steps of exemplary process 450 illustrated in FIG. 4B.

Referring to FIG. 4A, computing system 130 may establish a secure, programmatic channel of communication with one or more source computing systems, such as source systems 102 of FIG. 1, and may perform one or more of the exemplary processes described herein to obtain, from the source computing systems, elements of application data, such as application data records, that identify and characterize corresponding applications for the available products or services during the one or more prior temporal intervals (e.g., in step 402 of FIG. 4A). Computing system 130 may also perform any of the exemplary processes described herein to obtain, from the source computing systems, elements of external indicator data identifying and characterizing one or more external indicators during the one or more prior temporal intervals (e.g., also in step 402 of FIG. 4A).

Computing system 130 may also perform operations, such as those described herein, that store (or ingest) the obtained elements of application and external indicator data within one or more accessible data repositories, such as aggregated data store 144 (e.g., also in step 402 of FIG. 4A). In some instances, computing system 130 may perform operations, such as those described herein, to obtain and ingest the elements of application and external indicator data in accordance with a predetermined temporal schedule (e.g., on a monthly basis at a predetermined date or time, etc.), or a continuous streaming basis, across the secure, programmatic channel of communication.

In some instances, computing system 130 may access the ingested elements of application and external indicator data and may perform one or more of the exemplary processes described herein to selectively filter and pre-process the accessed elements of application data and the accessed elements of external indicator data (e.g., in step 404 of FIG. 4). Computing system 130 may also perform any of the exemplary processes described herein to aggregate selectively the filtered and pre-processed elements of application data and external indicator data 106 to generate a plurality of aggregated data records, which may be maintained within the one or more tangible, non-transitory memories of computing system 130, such as within a portion of aggregated data store 144 of FIG. 1 (e.g., also in step 404 of FIG. 4A).

By way of example, each of the elements of application data may be associated with a corresponding decision date within the one or more prior temporal intervals, and each of the aggregated data records may specify, for a corresponding one of the decision dates: (i) a number of initial submissions of applications adjudicated manually by the organization on the corresponding decision date; (ii) a total number of submitted applications adjudicated manually by the organization on the corresponding day (e.g., a sum of the initial submissions subject to manual adjudication and a number of resubmitted applications subject to manual adjudication on the corresponding decision date; (iii) a number of initial submissions of application adjudicated programmatically by the organization on the corresponding decision date; (iv) a total number of submitted applications adjudicated programmatically by the organization on the corresponding decision date (e.g., a sum of the initial submissions subject to programmatic adjudication and a number of resubmitted applications subject to programmatic adjudication on the corresponding decision date); a total number of submitted application adjudicated by the organization on the corresponding decision date (e.g., a sum of the total number of applications adjudicated manually and programmatically by the organization during the corresponding business day); and (vi) values of one of external indicators associated with the corresponding decision date (e.g., the housing starts, the household interest rate, the population, the number of residential sales, etc.).

Based on the decision dates specified by the aggregated data records, computing system 130 may perform any of the exemplary processes described herein to partition the aggregated data records into: a training and validation subset of the aggregated data records associated with adjudicated applications having decisions dates disposed within a training and validation interval Δt_{train/validate}, and as such, that may be appropriate to train adaptively and validate the time-series-based, hybrid neural-network process during the in-time training and validation interval Δt_{train/validate}; and (ii) testing subset of the aggregated data records associated with applications having decisions dates disposed within the out-of-time testing interval Δtₜₑₛₜ, and as such, that may be appropriate to testing the trained and validated, time-series-based, hybrid neural-network process on previously unseen data prior to deployment (e.g., in step 406 of FIG. 4A). Computing system 130 may also perform operations that decompose the aggregated data records of the training and validation subset into a training fold that facilitates the adaptive training the time-series-based, hybrid neural-network process during the in-time training and validation interval Δt_{train/validate}, and a validation fold that facilitates a validation of the trained time-series-based, hybrid neural-network process during the in-time training and validation interval Δt_{train/validate} (also in step 406 of FIG. 4A).

Computing system 130 may also perform any of the exemplary processes described herein to generate an initial training dataset associated with each, or a selected portion, of the aggregated data records allocated to the training fold of the training and validation subset (e.g., in step 408 of FIG. 4A). For example, each of initial training datasets may include temporal data identifying a corresponding decision date, an identifier of the target variable subject to prediction using the trained, time-series-based, hybrid neural-network process (e.g., the expected number of unique, initially submitted applications subject to manual adjudication by the organization on each day of the future temporal interval), and an incoming value of that target variable on the prediction date. Further, each of the initial training datasets may also include a plurality of candidate features, which may include, but are not limited to, all or a selected subset of the external indicator values maintained within the corresponding one of the aggregated data records.

Computing system 130 may also perform any of the exemplary operations described herein to generate initial process parameter values for the time-series-based, hybrid neural-network process (e.g., in step 410 of FIG. 4A). Examples of the initial process parameter values for the time-series-based, hybrid neural-network process, ay include, but are not limited to, parameters of the decomposable, time-series forecasting process of the time-series-based, hybrid neural-network process, one or more hyperparameters of the auto-regressive neural network associated with the time-series-based, hybrid neural-network process, and one or more global process parameters of the time-series-based, hybrid neural-network process, such as, but not limited to, those described herein.

In some instances, computing system 130 may also perform any of the exemplary operations described herein to train the time-series-based, hybrid neural-network process to predict, at a temporal prediction point, an expected number of unique, initially submitted applications subject to manual adjudication by the organization on each day of a future temporal interval, such as, but not limited to a twenty-eight day period. (e.g., in step 412 of FIG. 4A). Through the performance of these adaptive training processes, computing system 130 may perform operations in step 412 that compute a predicted value of the target variable (e.g., expected number of unique, initially submitted applications subject to manual adjudication by the organization) at each day of the future, target temporal interval as a sum the output values generated by the executed component modules of the time-series-based, hybrid neural-network process (e.g., executed trend module 220A, executed seasonality module 220B, executed event module 220C, executed future regression module 220D, executed AR module 220E, and executed lagged AR module 220F associated with the NeuralProphet™ process).

For each of the initial training datasets, computing system 130 may perform operations, described herein, that associate each of the predicted values of the target variable with a temporal identifier of the corresponding day within the future, target temporal interval and may package the associated temporal identifiers and predicted values into a corresponding element of training output (e.g., also in step 412 of FIG. 4A). Further, computing system 130 may perform any of the exemplary processes described herein to that compute, for each element of the training output, a value of one or more metrics that characterize a performance or accuracy of the time-series-based, hybrid neural-network process during application to corresponding ones of the initial training datasets, that associate each of the computed metric values within a corresponding one of the elements of the training output, and that store the associated elements of training output and the corresponding computed metric values within a data repository (e.g., also in step 414 of FIG. 4A).

Executed computing system 130 may also perform any of the exemplary processes described herein to add, subtract, or combine iteratively discrete features from initial training datasets and to generate elements of modified composition data that reflect the modifications to the composition of the initial training datasets (e.g., in step 416 of FIG. 4). Further, executed adaptive training module 218 may also generate one or more modified process parameter values, which may include all or a selected subset of the initial process parameter values, and which may also include values of one or more of the weights established during the implementation of the auto-regression neural networks, such as the fast-feed, auto-regression neural network described herein. (e.g., also, in step 416 of FIG. 4A). In some instances, computing system 130 may also store the elements of modified composition data and modified process data within a data repository (e.g., also in step 416 of FIG. 4A). Exemplary process 400 is then complete in step 418.

Referring to FIG. 4B, computing system 130 may perform any of the exemplary processes described herein to generate validation datasets associated with all, or a selected portion, the aggregated data records allocated to the validation fold in accordance with the modified composition data (e.g., in step 452 of FIG. 4B). As described herein, a composition, and a sequential ordering, of features values within each of the validation datasets may be consistent with the composition and corresponding sequential ordering set forth in the modified composition data.

Computing system 130 may also perform any of the exemplary processes described herein to validate the time-series-based, hybrid neural-network process against the elements of validation data included within each of the validation datasets, and in accordance with the parameter values included within the modified process data (e.g., in step 454 of FIG. 4B). As described herein, the time-series-based, hybrid neural-network process may include a NeuralProphet™ process that couples together a decomposable, time-series forecasting process within autoregression processing that leverages an auto-regressive neural network, and based on application of the time-series-based, hybrid neural-network process to each of the validation datasets, computing system 130 may perform any of the exemplary processes described herein to compute, for each of the validation datasets, a predicted value of the target variable (e.g., the expected number of unique, initially submitted applications subject to manual adjudication by the organization) at each day of the future, target temporal interval as a sum the output values generated by the executed component modules, including executed trend module 220A, executed seasonality module 220B, executed event module 220C, executed future regression module 220D, executed AR module 220E, and executed lagged AR module 220F (e.g., also in step 454 of FIG. 4B).

In some instances, computing system 130 may perform any of the exemplary processes described herein to associate each of the predicted values of the target variable with a temporal identifier of the corresponding day within the future, target temporal interval and that package the associated temporal identifiers and predicted values into a corresponding element of validation output data (e.g., also in in step 454 of FIG. 4B). Further, computing system 130 may perform operations, described herein, to compute, for each element of the validation output, a value of one or more metrics that characterize a performance or accuracy of the trained, time-series-based, hybrid neural-network process during validation against corresponding ones of the validation datasets, and may associate each of the computed metric values within a corresponding one of the elements of validation output and store the associated elements of validation output and the corresponding computed metric values within the data repository (e.g., also in step 456 of FIG. 4B).

In some examples, computing system 130 may perform any of the exemplary processes described herein to whether all, or a selected portion of, the computed metric values satisfy one or more threshold validation conditions (e.g., in step 458 of FIG. 4B). If, for example, computing system 130 were to establish that one, or more, of the computed metric values fail to satisfy at least one of the threshold validation conditions (e.g., step 458; NO), computing system 130 may establish that the adaptively trained, gradient-boosted, decision-tree process is insufficiently accurate for a real-time application to the elements of confidential data described herein, and computing system 130 may perform operations that train further the time-series-based, hybrid neural-network against elements of training data included within additional training datasets (e.g., in step 460 of FIG. 4B). Exemplary process 450 is then complete in step 462.

Alternatively, computing system 130 to establish that each computed metric value satisfies the threshold validation conditions (e.g., step 458; YES), computing system 130 may deem the trained, time-series-based, hybrid neural-network successfully validated, and may generate elements of validated composition data, which characterizes a composition of an input dataset for the adaptively trained, and now validated, time-series-based, hybrid neural-network process (e.g., in step 464 of FIG. 4B).

Computing system 130 may also perform any of the exemplary processes escribed herein to adaptively or dynamically tune one or more of the parameters of the decomposable, time-series forecasting process of the time-series-based, hybrid neural-network process, and one or more of the hyperparameters of the auto-regressive neural network associated with the time-series-based, hybrid neural-network process, based on data characterizing the initial training and subsequent validation of the time-series-based, hybrid neural-network process (e.g., in step 466 of FIG. 4B). By way of example, computing system 130 may perform a Bayesian optimization process, such as an Optuna™ optimization process, that tunes the parameters of the decomposable, time-series forecasting process and the hyperparameters of the auto-regressive neural network. In some instances, computing system 130 may package the tuned values of the parameters of the decomposable, time-series forecasting process and the hyperparameters of the auto-regressive neural into a corresponding portion of tuned process data, which may be stored within the data repository (e.g., and executed adaptive training module 218 may perform operations that store the elements of validated composition data 236 and tuned process data 240 within aggregated data store 144 (e.g., also in step 466 of FIG. 4B).

In some instances, computing system 130 may perform operations that test the trained and validated time-series-based, hybrid neural-network process against the elements of out-of-time testing data included within corresponding testing datasets, and in accordance with the parameter and hyperparameter values included within the tuned process data (e.g., in step 468 of FIG. 4B). For example, and based on an application of the trained and validated time-series-based, hybrid neural-network process to the testing datasets, computing system 130 may perform any of the exemplary processes described herein to compute, for each of the testing datasets, a predicted value of the target variable (e.g., the expected number of unique, initially submitted applications subject to manual adjudication by the organization) at each day of the future, target temporal interval as a sum the output values generated by the executed component modules, including executed trend module 220A, executed seasonality module 220B, executed event module 220C, executed future regression module 220D, executed AR module 220E, and executed lagged AR module 220F (e.g., also in step 468 of FIG. 4B).

In some instances, computing system 130 may perform any of the exemplary processes described herein to associate each of the predicted values of the target variable with a temporal identifier of the corresponding day within the future, target temporal interval and that package the associated temporal identifiers and predicted values into a corresponding element of testing output data (e.g., in step 470 of FIG. 4B). Further, computing system 130 may perform operations, described herein, to compute, for each element of the testing output, a value of one or more metrics that characterize a performance or accuracy of the trained, time-series-based, hybrid neural-network process during validation against corresponding ones of the testing datasets, and may associate each of the computed metric values within a corresponding one of the elements of validation output and store the associated elements of testing output and the corresponding computed metric values within the data repository (e.g., also in step 470 of FIG. 4B).

In some examples, computing system 130 may perform any of the exemplary processes described herein to whether all, or a selected portion of, the computed metric values satisfy one or more threshold testing conditions (e.g., in step 472 of FIG. 4B). If, for example, computing system 130 were to establish that one, or more, of the computed metric values fail to satisfy at least one of the threshold testing conditions (e.g., step 472; NO), computing system 130 may establish that the adaptively trained, gradient-boosted, decision-tree process is insufficiently accurate for a real-time application to the elements of confidential data described herein, and computing system 130 may perform operations that train further the time-series-based, hybrid neural-network against elements of training data included within additional training datasets (e.g., in step 460 of FIG. 4B). Exemplary process 450 is then complete in step 462.

Alternatively, if computing system 130 were to establish that each computed metric value satisfies the threshold testing conditions (e.g., step 472; YES), computing system 130 may deem the trained and validated, time-series-based, hybrid neural-network ready for deployment, and may generate elements of final composition data and final parameter data associated with the time-series-based, hybrid neural-network process, which may be stored within the data repository (e.g., in step 474 of FIG. 4B). Exemplary process 450 is then complete in step 462.

FIG. 4C is a flowchart of an exemplary process 480 for predicting application numbers on each day during a future temporal interval, in accordance with some examples. The future temporal interval may, for example, correspond to a twenty-four-day temporal interval, and in some instances, one or more computing systems, such as, but not limited to, one or more of the distributed components of computing system 130, may perform one or of the steps of exemplary process 480, as described herein.

Referring to FIG. 4C, computing system 130 may perform operations, described herein, that access elements of schedule data that identifies a corresponding, temporal prediction date (e.g., in step 482 of FIG. 4C). Computing system 130 may also perform any of the exemplary processes described herein to generate an input dataset having a sequential composition consistent with elements of final composition data associated with the trained time-series-based, hybrid neural-network process (e.g., in step 484 of FIG. 4C).

Computing system 130 may also perform any of the exemplary processes described herein that apply the trained, time-series-based, hybrid neural-network process to the feature values within the input dataset in accordance with the parameter values and the hyperparameter values within final process data, and that based on the application of the trained, time-series-based, hybrid neural-network process to the feature values, elements of output data indicative of the expected number of unique, initially submitted applications subject to manual adjudication by the organization on each day of the future temporal interval (e.g., in step 486 of FIG. 4C). As described herein, the trained, time-series-based, hybrid neural-network process may include a NeuralProphet™ process that couples together a decomposable, time-series forecasting process with autoregression processing that leverages an auto-regressive neural network. In some instances, computing system 130 may perform any of the exemplary processes described herein to compute a predicted value of the target variable (e.g., expected number of unique, initially submitted applications subject to manual adjudication) at each day of the future, target temporal interval as a sum the output values generated by executed trend module 220A, executed seasonality module 220B, executed event module 220C, executed future regression module 220D, executed AR module 220E, and executed lagged AR module 220F for that corresponding day (e.g., also in step 486 of FIG. 4C). Computing system 130 may also associate each of the predicted values of the target variable with a temporal identifier of the corresponding day within the future, target temporal interval and may package the associated temporal identifiers and predicted values into a corresponding element of output data (e.g., also in step 486 of FIG. 3C).

Computing system 130 may also perform any of the exemplary processes described herein to apply a multiplier-based extrapolation process to the output of the trained time-series-based, hybrid neural-network process and to generate, for each day within the target, future temporal interval, an extrapolated value representative of the expected, total number of all submitted applications (e.g., initial submissions and resubmissions) subject to manual adjudication by the organization on each day of the future temporal interval, which may be packaged into corresponding elements of extrapolated output data (e.g., in step 488 of FIG. 4C). In some instances, computing system 130 may perform operations, described herein, that apply one or more post-processing operations to the elements of output data and extrapolated output data (e.g., in step 490 of FIG. 4C).

Computing system 130 may also perform any of the exemplary processes described herein to perform operations to allocate, or modify a prior allocation of, physical or computational resources to address the expected number of initially submitted applications, and the expected number of all applications (e.g., in step 492 of FIG. 4C). In some example, the performed operations may include, but are not limited to, generating elements of allocation data, or re-allocation data, that, when transmitted to adjudication system 306 associated with the organization and with the programmatic, or manual, approval of the applications for the available products or services, controls the operation of that computing system and causes the computing system to allocate, or re-allocate physical and computational resources to address the predicts application numbers on each day of the future temporal interval. Exemplary process 480 is then complete in step 494.

### B. Exemplary Computer-Implemented for Training and Deploying Time-Series Regression Processes in Distributed Computing Environments

As described herein, computing system 130 may perform operations that predict, on a short-term basis, an expected number of unique, initially submitted applications subject to manual adjudication by the organization based on an application of a trained, time-series-based, hybrid neural-network process to corresponding input datasets, the extrapolate the predictive output of the trained, time-series-based, hybrid neural-network process and determine an expected number of all submitted applications (e.g., initially submitted applications and resubmitted applications) subject to manual adjudication by the organization, and that provision the expected number of unique, initially submitted applications, and the expected number of all submitted applications, to one or more computing systems of the organization (e.g., adjudication system 306) that support the manual adjudication of these submitted applications. In some instances, adjudication system 306 may perform operations, described herein, that allocate, or modify a prior allocation of, physical or computational resources to address the expected number of initially submitted applications, and the expected number of all applications, subject to manual adjudication on the short-term basis. For example, on the short-term basis, adjudication system 306 may perform operations that increase an allocation of computational bandwidth available to individual underwriters associated with the manual adjudication of submitted application, and additionally or alternatively, that increase an amount of computing hardware available to the individual underwriters, e.g., to facilitate the manual adjudication of these submitted applications in the short-term.

In some instances, data characterizing an expected number of initially submitted applications, and an expected number of all applications, subject to manual adjudication across a future temporal interval of greater duration may assist, and facilitate, an allocation of computational resources and computational hardware on a long-term basis. For example, and as described herein, organization may manage a distributed computing network, and data characterizing an increase in an expected number of initially submitted applications, and an expected number of all applications, subject to manual adjudication during a future, three-month period may cause the organization to access to additional computational resources over the next three months to not only facilitate the manual adjudication of these submitted applications, but to also facilitate the subsequent access of these computational resources by customers, e.g., upon approval of subsets of the submitted applications. Further, by way of example, the organization may include a financial institution, and the data characterizing an increase in an expected number of initially submitted applications, and an expected number of all applications, subject to manual adjudication during a future, three-month period may also cause the financial institution to re-allocate computational resources, or to obtain access to additional computational resources, to facilitate the manual adjudication of these submitted applications and to provision and manage the services of products associated with approved applications.

While certain of the exemplary processes described herein may facilitate a prediction of a number of manual submissions expected by the organization on each day of a future, target temporal interval, these predicted output provided by these exemplary, short-term predictive processes, and a temporal granularity of the predicted, short-term output, may be ill suited to inform the organization's allocation or re-allocation of computational or physical resources over future temporal interval of longer duration, such as a temporal interval of three months. For example, the order of the auto-regression processes described herein, when coupled with the fourteen-day prior temporal interval leveraged by the multiplier-based extrapolation processes described herein, may limit both an ability of these exemplary processes to provide predicted output data at discrete temporal positions within a long-term temporal interval extending between twelve and twenty-four months from a temporal prediction point, and an accuracy of the output data predicted simultaneously at least of these discrete temporal positions.

In some examples, described herein, computing system 130 may perform operations that train adaptively an additional machine-learning process, such as a time-series linear regression process, to predict, at a temporal prediction point, an expected number of unique, initially submitted applications subject to manual and programmatic adjudication by the organization on a monthly basis during a future, target temporal interval that extends three months from the temporal prediction point. The expected number of unique, initially submitted applications subject to manual and programmatic adjudication by the organization across the future, target temporal interval, may, for instance, be impacted by and parameterized as a function of the value of one or more of the external indicators described herein, and the exemplary processes that train the time-series linear regression process may leverage a determination of a relationship between these external indicator values and the expected, number of unique, initially submitted applications subject to manual and programmatic adjudication by the organization over one or more prior temporal intervals.

Further, and as described herein, computing system 130 may also perform operations that apply a staged, multiplier-based process to an output of the trained time-series linear regression process, and based on the application of the staged, multiplier-based process to an output of the trained time-series linear regression process, computing system 130 may perform operations that determine an expected number of unique, initially submitted applications subject to manual adjudication by the organization (e.g., as a product of the predicted number of unique, initially submitted applications subject to manual and programmatic adjudication and a corresponding net automation rate), and that determine an expected, total number of submitted applications subject to manual adjudication by the organization (e.g., as a product of the predicted number of unique, initially submitted applications subject to manual adjudication and a corresponding manual resubmission rate).

In some instances, the distributed computing components of computing system 130 (e.g., that include one or more GPUs or TPUs configured to operate as a discrete computing cluster) may perform any of the exemplary processes described herein to adaptively train and test the time-series linear regression process in parallel through an implementation of one or more parallelized, fault-tolerant distributed computing and analytical processes. Based on an outcome of these adaptive training processes, computing system 130 may generate process coefficients, parameters, thresholds, and other process data that collectively specify the trained time-series linear regression process, and may store the generated process coefficients, parameters, thresholds, and process data within a locally or remotely accessible data repository.

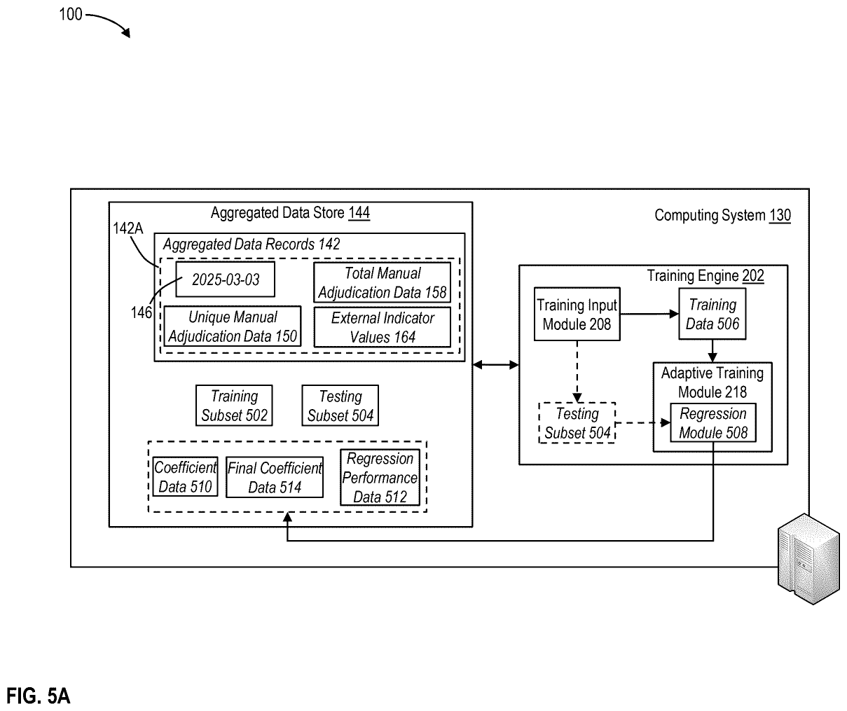

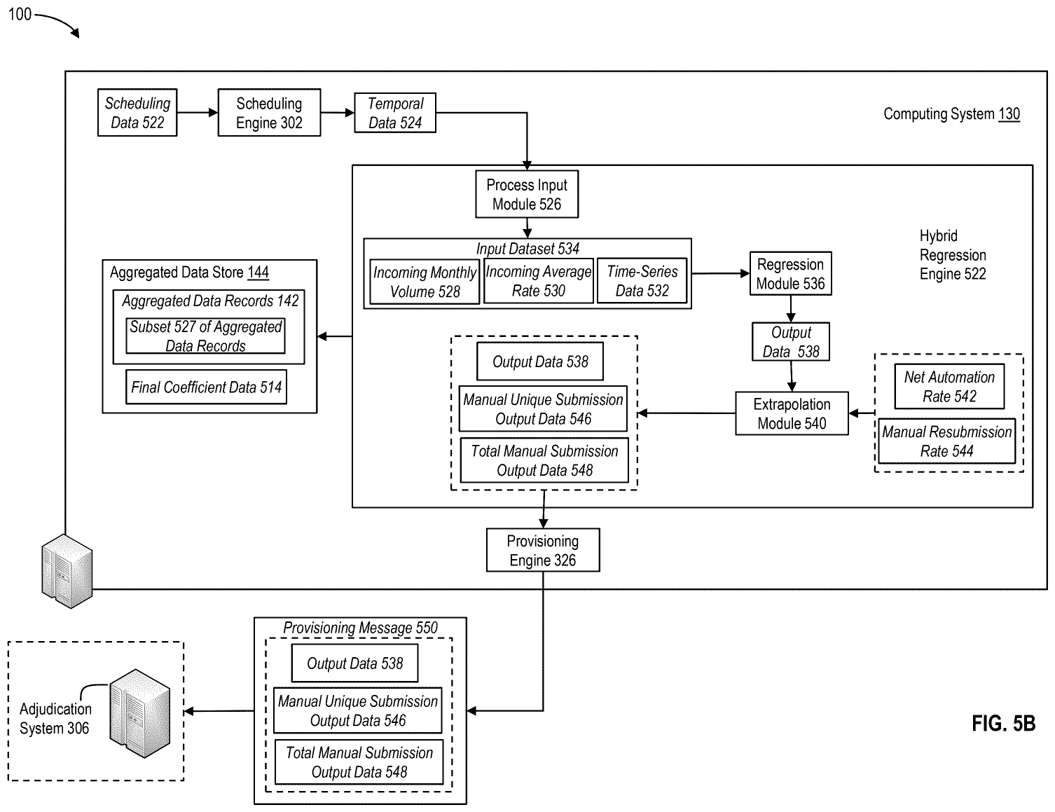

Referring to FIG. 5A, executed training input module 208 may access portions of aggregated data records 142 maintained within aggregated data store 144, such as, but not limited to, data record 142A. As described herein, each of aggregated data records 142 may be associated with a corresponding business day within the one or more prior temporal intervals described herein, and each of aggregated data records 142 may include a temporal identifier of the corresponding business day, may identify and characterize, among other things, a number of unique, initial submissions of applications adjudicated manually, and adjudicated programmatically by the organization during the corresponding business day, and may also include values of one or more external indicators during the corresponding business day. For example, data record 142A of aggregated data records 142 may include temporal data 146 that specifies the corresponding business day (e.g., Mar. 3, 2025), elements of unique manual adjudication data 150, which specify a number of initially submitted applications that were adjudicated manually by the organization on Mar. 3, 2025, elements of unique programmatic adjudication data 152, which specify a number of initially submitted applications that were adjudicated programmatically by the organization on Mar. 3, 2025, and external indicator values 164, which includes values of one or more of the external indicators on Mar. 3, 2025, such as, but not limited to, the values of the housing starts, the household interest rate, the population, the number of residential sales on Mar. 3, 2025.

In some instances, executed training input module 208 may process each of aggregated data records 142 and generate additional, processed data records associated with corresponding months within the one or more prior temporal intervals. Each of the additional processed data records may include additional temporal data that specifies the corresponding month, an aggregated, total number of unique, initial submissions of applications adjudicated manually and programmatically by the organization during the corresponding month, and average values of the one or more external indicators across the corresponding month.

For example, executed training input module 208 may parse aggregated data records 142 and identify a subset of the parsed data records associated with decision dates disposed within a corresponding month of the one or more prior temporal intervals. Executed training input module 208 may obtain from each of the data records of the subset, the total number of unique, initial submissions of applications adjudicated manually and programmatically, by the organization during the corresponding business day, and may compute a sum of the numbers of the unique, initial submissions of applications adjudicated manually and adjudicated programmatically by the organization during the business day. In some instances, executed training input module 208 may aggregated the computed sums across the business days of the corresponding month, and package the aggregated value of the total number of the unique, initial submissions of applications adjudicated manually and programmatically by the organization during the corresponding month and a temporal identifier of the corresponding month within a corresponding one of the additional, processed data records.

Further, in some examples, executed training input module 208 may also obtain, from each of the data records of the subset, the values of one or more of the external indicators associated with each of the business days, and executed training input module 208 may perform operations that compute an average value of each of the one or more external indicators for the corresponding month, and package the average values of the one or more external indicators into the corresponding, additional, processed data record, e.g., in association with the temporal identifier of the corresponding month and with the aggregated, total number of the unique, initial submissions of applications adjudicated manually and programmatically by the organization during the corresponding month. Executed training input module 208 may also perform any of the exemplary processes described herein to generate an additional, processed data record for each additional month disposed within the one or more prior temporal intervals of aggregated data records 142.

Referring back to FIG. 5A, Executed training input module 208 module also perform any of the exemplary processes described herein to partition the additional processed data records into (i) a training subset 502 of the additional, processed data records appropriate to train adaptively the time-series linear regression process during the in-time training and validation interval Δt_{train/validate}; and (ii) a testing subset 504 of the additional, processed data records are adjudicated applications having decisions dates disposed within the out-of-time testing interval Δtₜₑₛₜ, and as such, may be appropriate to test the adaptively trained time-series linear regression process on previously unseen data prior to deployment. In some instances, executed training input module 208 may perform operations that generate elements of training data 506 associated with each, or a selected portion, training subset 502 of the additional, processed data records 142. For instance, the total number of the unique, initial submissions of applications adjudicated manually and adjudicated programmatically by the organization during a corresponding month may depend on, among other things, one or more of the external indicators, such as, but not limited to, an average value of the household interest rate during the corresponding month. As described herein, each data record of training subset 502 may include an average value of the household interest rate during the corresponding month (e.g., within the average values of the one or more external indicators).

Executed training input module 208 may parse the data records of training subset 502, and for each of the additional, processed data records and the corresponding month, executed training input module 208 may generate an element of training data 506 that includes, but is not limited to, the temporal identifier associated with the corresponding month, the total number of the unique, initial submissions of applications adjudicated manually and programmatically by the organization during the corresponding month, and the average value of the household interest rate across the corresponding month. The disclosed embodiments are not limited to these exemplary variables, and in other instances, the elements of training data 506 may include values of any additional or alternate variables present within aggregated data records 142, or derivable aggregated data records 142, that parameterizes the expected number of unique, initially submitted applications subject to manual and programmatic adjudication.

Executed training input module 208 may provide training data 506 as an input to executed adaptive training module 218 of executed training engine 202. In some instances, executed adaptive training module 218 may perform operations that adaptively train the time-series linear regression process based on an application of a time-series regression process to each of the elements of training data 506, e.g., which collectively establish a time series of the total number of the unique, initial submissions of applications adjudicated manually and adjudicated programmatically by the organization and average values of household interest rates during successive months.

For example, a regression module 508 of executed adaptive training module 218 may, for example, treat the time dependence characteristic of the time-varying numbers of the unique, initial application submissions and the average values of the household interest rates as an independent variable, and executed regression module 508 may perform operations that apply an ordinary least squares (OLS) regression process to each of the elements of training data 506, e.g., treating the numbers of the unique, initial application submissions, the average values of the household interest rates, and the time as independent variables associated with corresponding regression coefficients. In some instances, executed regression module 508 may account for seasonality effects associated with the numbers of the unique, initial application submissions using any of the exemplary processes described herein (e.g., based on a configurable number of Fourier terms with a specific, and configurable, periodicity), as a binary variable (e.g., zero or unity based on the temporal prediction point), or based on data maintained within aggregated data records 142 and associated with prior temporal intervals.

In some instances, and based on the application of the OLS regression process to each of the elements of training data 506, executed regression module 508 may generate elements of coefficient data 510, which may include a value of an intercept and regression coefficients for each of the independent variables, such as, but not limited to, the numbers of the unique, initial application submissions, the average values of the household interest rates, and the time. Executed training input module 208 may store the elements of coefficient data 510 within aggregated data store 144, and based on the elements of coefficient data 510, executed training input module 208 may access the elements of testing subset 504, which may be associated with corresponding ones of the months disposed within the one or more prior temporal intervals aggregated data records 142, and for each of the elements of testing subset 504, perform operations, consistent with the intercept and regression coefficients within coefficient data 510, that compute a predicted, total number of the unique, initial submissions of applications adjudicated manually and programmatically by the organization during each of the successive three months. Based on the actual number of the unique, initial submissions of applications adjudicated manually and programmatically by the organization maintained within the elements of testing subset 504, and on corresponding ones of the predicted numbers, executed adaptive training module 218 may determine a value of the one or more metrics that characterize a performance or accuracy of trained, time-series linear regression process.

Examples of these one or more metrics may include, but are not limited to, the mean absolute error (MAE), the mean absolute percentage error (MAPE), and the mean absolute scaled error (MASE) described herein, and executed adaptive training module 218 may associate each of the computed metric values within a corresponding one of the elements of testing subset 504 and may package the computed metric values into corresponding elements of regression performance data 512, which executed adaptive training module 218 may store within aggregated data store 144.

In some examples, executed adaptive training module 218 may also perform operations that determine whether all, or a selected portion of, the computed metric values satisfy one or more threshold testing conditions. For instance, the threshold testing conditions may specify one or more predetermined threshold values for the trained, time-series linear regression process, such as, but not limited to, predetermined threshold values for the computed MAE values, the computed MAPE values, and/or the computed MASE values. In some examples, executed adaptive training module 218 that establish whether one, or more, of the computed MAE values, the computed MAPE values, and/or the computed MASE values exceed, or fall below, a corresponding one of the predetermined threshold values and as such, whether the performance or accuracy of the trained, time-series linear regression process satisfies the threshold validation conditions.

If, for example, executed adaptive training module 218 were to establish that one, or more, of the computed metric values fail to satisfy at least one of the threshold testing conditions, computing system 130 may establish that the trained time-series linear regression process is insufficiently accurate for a real-time application to the elements of confidential data described herein. Executed adaptive training module 218 may perform operations (not illustrated in FIG. 5A) that transmit data indicative of the established inaccuracy to executed training input module 208, which may perform any of the exemplary processes described herein to generate one or more additional training datasets, which may be provisioned to executed adaptive training module 218. In some instances, executed adaptive training module 218 may receive the additional training datasets, and may perform any of the exemplary processes described herein to train further the time-series linear regression process against the elements of training data included within each of the additional training datasets.

Alternatively, if executed adaptive training module 218 were to establish that each computed metric value satisfies the threshold testing conditions, executed adaptive training module 218 may deem the trained, time-series linear regression process ready for deployment, and may generate elements of final coefficient data 514, which includes the intercept and each of the regression coefficients of the trained, trained, time-series linear regression process. Executed adaptive training module 218 may also store final coefficient data 514 within aggregated data store 144.

Further although not illustrated in FIG. 5A, computing system 130 may continue to monitor a performance and an accuracy of the time-series linear regression process subsequent to its deployment and ingestion of elements of confidential data maintained within the organization. For example, computing system 130 may monitor one or more of the metric values characterizing the performance or accuracy of the time-series linear regression process on a weekly, monthly, or quarterly basis subsequent to deployment, and should one or more of these metric values fall below a corresponding threshold value, computing system 130 may perform operations that initiate a retraining of the time-series linear regression process using any of the exemplary processes described herein.

In other examples, the successful training of the time-series linear regression process may be associated with a corresponding period of validity that, once expired, triggers a retraining of the time-series linear regression process by computing system 130 using any of the exemplary processes described herein. By way of example, the corresponding period of validity may include a two-week period, and upon expiration of this initial, two-week period, computing system 130 may perform any of the exemplary processes to training further the time-series linear regression process using additional training, validation, and testing datasets that include elements of newly ingested, and aggregated, data maintained within aggregated data records 142.

In some instances, described herein, a time-series linear regression process may be trained to predict, at a temporal prediction point, an expected number of unique, initially submitted applications subject to both manual and programmatic adjudication on a monthly basis during a future temporal interval, such as, but not limited to, three-month period subsequent to the temporal prediction point. For example, and based on an application of the trained, time-series linear regression process to input data in accordance with adaptively determined regression coefficients, the one or more distributed components of computing system 130 may generate elements of output data indicative of an expected, total number of unique, initially submitted applications subject to manual and programmatic adjudication by the organization (e.g., a regression target variable) on a monthly basis during the future, target temporal interval. Each of the generated elements of output data may be associated with a corresponding month within the future, target temporal interval (e.g., a first business day or a last business day of the corresponding month, etc.), and may associate together a temporal identifier of that corresponding month (e.g., an alphanumeric text string, etc.) and a numerical value of the regression target variable during the corresponding month.

Computing system 130 may also perform operations, described herein, that apply a staged, multiplier-based extrapolation process to each of the elements of output data, e.g., the expected, total number of unique, initially submitted applications subject to manual adjudication and subject to programmatic adjudication by the organization on the monthly basis during the future, target temporal interval. Based on the application of the staged, multiplier-based extrapolation process to each of the elements of output data, computing system 130 may derive an expected, number of unique, initially submitted applications subject to manual adjudication by the organization on the monthly basis during the future, target temporal interval (e.g., based on a new automation rate associated with the adjudication of the submitted applications) and an expected, number of all applications (e.g., initial submissions and resubmissions) subject to manual adjudication by the organization on the monthly basis during the future, target temporal interval (e.g., based on a manual resubmission rate associated with the adjudication of the submitted applications).

The net automation rate and the manual resubmission rate may both represent inputs to the staged, multiplier-based extrapolation process, and in some instances, computing system 130 may perform operations, described herein, to determine a value of at least one of net automation rate or the manual resubmission rate at the temporal prediction date based on an analysis of the aggregated data records maintained within aggregated data store 144. In other instances, the value of the net automation rate and/or the manual resubmission rate may depend on a value or a change in a value of one or more of the external indicators described herein (e.g., a household interest rate, a gross domestic product, etc.), on seasonality effects, or on one or more external processes implemented by computing system 130 (e.g., to modifications to the manual or programmatic adjudication processes, etc.). For example, the value of the net automation rate and/or the manual resubmission rate may be determined based on an output of one or more stochastic simulation processes, such as, but not limited to, the exemplary Monte Carlo simulation processes described herein. Further, computing system 130 may perform any of the exemplary processes described herein to apply the trained, time-series linear regression process to the input data, and to apply the staged, multiplier-based extrapolation process to the output data, in accordance with a predetermined schedule, e.g., on a quarterly basis, etc., or based on a request generated programmatically by an application program executed by adjudication system 306.

Referring to FIG. 5B, executed scheduling engine 302 may access elements of schedule data 520, which may be maintained within the tangible, non-transitory memories of computing system 130. Executed scheduling engine 302 may parse scheduling data 520 and may determine that computing system 130 is scheduled to provision, to adjudication system 306 on Mar. 3, 2025 (e.g., a prediction date), data characterizing an expected, total number of submitted applications subject to manual adjudication and to programmatic adjudication by adjudication system 306 on a monthly basis during a future temporal interval extending from Mar. 4, 2025, through Jun. 3, 2025 (e.g., a three-month temporal internal). The disclosed embodiments are, however, not limited to three-month temporal intervals, and in other instances, the long-term temporal interval may include a six-month temporal interval, a twelve-month temporal interval, or any additional, or alternate, temporal interval appropriate to the trained, time-series regression process.

Based on the determination, executed scheduling engine 302 may perform operations that cause the one or more processors of computing system 130 to execute a hybrid regression engine 522, which may facilitate an application of the trained, time-series linear regression process to corresponding input data associated with the Mar. 3, 2025, prediction date and an application of the staged, multiplier-based extrapolation process to predictive output of the trained, time-series linear regression process. In some instances, executed scheduling engine 302 may provision elements of temporal data 524, which indicates the prediction date of Mar. 3, 2025, to executed hybrid regression engine 522. A process input module 526 of executed hybrid regression engine 522 may receive temporal data 524, which specifies the Mar. 3, 2025, prediction date (e.g., the first business day of March 2025), and executed process input module 310 may access aggregated data store 144 and obtain a subset 527 of the aggregated data records associated with decision dates on business days that fall in a prior, monthly temporal interval (e.g., between Feb. 1, 2025, and Feb. 28, 2025). As described herein, each of the accessed, aggregated data records may include: temporal data, which identifies a corresponding prediction date; elements of unique manual adjudication data, which specify a total number of initially submitted applications adjudicated manually on the corresponding prediction date; elements of unique programmatic adjudication data, which specify a total number of initially submitted applications adjudicated programmatically on the corresponding prediction date; elements of total manual adjudication data, which specify a total number of all applications (e.g., initial submissions and resubmissions) adjudicated manually on the corresponding prediction date; and values of the one or more external indicators on the corresponding prediction date.

Executed process input module 526 may also perform any of the exemplary processes described herein to aggregate the specified numbers of initially submitted applications adjudicated manually by the organization and the specified numbers of initially submitted applications adjudicated programmatically across the decision dates of subset 527 of the aggregated data records, and to determine a total number of initially submitted applications adjudicated manually and programmatically by the organization across the prior, monthly temporal interval (e.g., an incoming monthly number 528 of adjudicated, initially submitted applications). Further, and based on subset 527 of aggregated data records, process input module 526 may also perform any of the exemplary processes described herein to determine an average value of pone or more of the external indicators, such as the household interest rate, across the prior, monthly temporal interval (e.g., an incoming average household interest rate 530). As described herein, incoming monthly number 528 of adjudicated, initially submitted applications and the incoming average household interest rate 530 may each represents independent variables of the trained, time-series regression process.

Further, executed process input module 526 may also generate elements of time-series data 532 for input into the trained, trained, time-series regression process. The time-series data 532 may specify a plurality of temporal positions within the future, target temporal interval associated with the predictive output of the trained, time-series regression process. For example, the trained, time-series regression process may generate output data characterizing the expected, total number of unique, initially submitted applications subject to manual adjudication and subject to programmatic adjudication by the organization on a monthly basis during the future, target temporal interval, and for the three-month temporal interval described herein, time-series data 532 may specify include temporal identifiers of Mar. 31, 2025, Apr. 30, 2025, and May 30, 2025 (e.g., the final business day of each calendar month within the three-month, future, target temporal interval).

In some instances, executed process input module 526 may package incoming monthly number 528, incoming average household interest rate 530, and time series data 532 into corresponding portions of an input dataset 534, and executed process input module 526 may provision input dataset 534 as an input to a regression module 536 of executed hybrid regression engine 522. Further, executed regression module 536 may obtain, from aggregated data store 144, elements of final coefficient data 514, which include the intercept and each of the regression coefficients of the trained, trained, time-series linear regression process. Executed regression module 536 may apply the trained, time-series regression process to the independent variables included within input dataset 534 (e.g., incoming monthly number 528, incoming average household interest rate 530, and time series data 532) in accordance with final coefficient data 514, and based on the application of the trained, time-series regression process to the independent variables included within input dataset 534, executed regression module 536 may generate the expected, total number of unique, initially submitted applications subject to manual adjudication and programmatic adjudication by the organization during each month of the future, target temporal interval specified within time series data 532.

Executed hybrid processing module 316 may also associate each of the predicted values of the regression target variable (e.g., total number of unique, initially submitted applications subject to manual adjudication and programmatic adjudication by the organization during each month of the future, target temporal interval) with a corresponding one of the temporal identifiers within time series data 532 (e.g., the temporal identifiers representing Mar. 31, 2025, Apr. 30, 2025, and May 30, 2025), and may package the associated temporal identifiers and predicted values into a corresponding element of output data 538. For example, output data 538 may include a first element that includes the expected, total number of unique, initially submitted applications subject to manual and programmatic adjudication by the organization during March 2025 (and is associated with the temporal identifier of Mar. 31, 2025), a second element that includes the expected, total number of unique, initially submitted applications subject to manual and programmatic adjudication by the organization during April 2025 (and is associated with the temporal identifier of Apr. 30, 2025), and a third element that includes the expected, total number of unique, initially submitted applications subject to manual and programmatic adjudication by the organization during May 2025 (and is associated with the temporal identifier of May 30, 2025). The disclosed embodiments are, however, not limited to these exemplary elements of predictive output 538 and these exemplary temporal intervals, and in other instances, predictive output 538 may include elements associated with any additional, or alternate, monthly intervals appropriate to the trained, time-series regression process and to time series data 532.

Executed regression module 536 may provision the elements of output data 538 as an input to an extrapolation module 540 of executed hybrid regression engine 522, which perform any of the exemplary processes described herein to apply the staged multiplier-based extrapolation process to the each of the elements of output data 538. As described herein, each of the elements of output data 538 may include an expected, monthly total number of unique, initially submitted applications subject to manual adjudication and programmatic adjudication by the organization during each month of the future, target temporal interval (e.g., during March, April, and May of 2025). In some instances, within the staged multiplier-based extrapolation process, executed extrapolation module 540 may obtain a value of a net automation rate 542 associated with the adjudication process, and the value of net automation rate 542 may specify the portion of submitted application that are not subject to programmatic adjudication during any stage of the organization's decisioning process. As described herein, the value of net automation rate 542 may be determined by computing system 130 based on an analysis of the aggregated data records maintained within aggregated data store 144 and additionally, or alternatively, may be determined based on an output of one or more stochastic simulation processes, such as, but not limited to, the exemplary Monte Carlo simulation processes described herein.

In some instances, executed extrapolation module 540 may access each of the elements of output data 538, and for each of the accessed elements, executed extrapolation module 540 may compute a product of (i) the value of net automation rate 542 and (ii) the corresponding regression target variable (e.g., total number of unique, initially submitted applications subject to manual adjudication and programmatic adjudication by the organization during the corresponding month of the future, target temporal interval). As described herein, each of these computed products may represent the number of unique, initially submitted applications subject to manual adjudication by the organization during the corresponding month of the future, target temporal interval, and executed extrapolation module 540 may perform operations that associate each of these computed products with a corresponding one of the temporal identifiers, and may package the associated pairs of computed products and temporal identifiers into a corresponding element of manual unique submission output data 546.

Further, and within the staged multiplier-based extrapolation process, executed extrapolation module 540 may obtain a value of a manual resubmission rate 544 associated with the adjudication process, and the value of manual submission rate 544 may reflect a likelihood that unique, initially submitted applications will be resubmitted, and manually adjudicated, subsequent to an initial, manual adjudication by the organization. As described herein, the value of manual submission rate 544 may be determined by computing system 130 based on an analysis of the aggregated data records maintained within aggregated data store 144 and additionally, or alternatively, may be determined based on an output of one or more stochastic simulation processes, such as, but not limited to, the exemplary Monte Carlo simulation processes described herein.

In some instances, executed extrapolation module 540 may access each of the elements of manual unique submission output data 546, which specify a determined number of unique, initially submitted applications subject to manual adjudication by the organization during a corresponding month of the future, target temporal interval (e.g., March, April, and May of 2025). For each of the accessed elements of manual unique submission output data 546, executed extrapolation module 540 may compute a product of (i) the value of the manual resubmission rate and (ii) the determined number of unique, initially submitted applications subject to manual adjudication by the organization during the corresponding month. As described herein, each of these additional computed products may represent the total number of applications (e.g., initial submissions and resubmissions) subject to manual adjudication by the organization during the corresponding month, and executed extrapolation module 540 may perform operations that associate each of these additional computed products with a corresponding one of the temporal identifiers, and may package the associated pairs of determined numbers and temporal identifiers into a corresponding element of total manual submission output data 548.

As illustrated in FIG. 5B, executed hybrid predictive engine 308 may provide the elements of output data 538, manual unique submission output data 546, and total manual submission data 548 as inputs to a provisioning engine 326 executed by the one or more processors of computing system 130. Executed provisioning engine 326 may package the post-processed elements of output data 538, manual unique submission output data 546, and total manual submission data 548 into corresponding portions of a provisioning message 550, which computing system 130 may transmit across network 120 to an adjudication system 306 associated with the organization and with the programmatic, or manual, approval of the applications for the available products or services.

In some instances, one or more processors of adjudication system 306 may execute an application programs that cause adjudication system 306 to receive provisioning message 550, to obtain: the elements of output data 538, which specify the total, monthly number of unique, initially submitted applications subject to manual adjudication and programmatic adjudication by the organization during corresponding ones of March, April, and May 2025; the elements of manual unique submission output data 546, which specify the monthly number of unique, initially submitted applications subject to manual adjudication by the organization during corresponding ones of March, April, and May 2025; and the elements of total manual submission data 548, which specify the total, monthly number of applications (e.g., initial submissions and resubmissions) subject to manual adjudication by the organization corresponding ones of March, April, and May 2025. Further, although not illustrated in FIG. 3, adjudication system 306 may perform operations, described herein, that allocate, or modify a prior allocation of, physical or computational resources to address the expected number of initially submitted applications, and the expected number of all applications, subject to manual adjudication on a long-term basis between March, April, and May 2025.

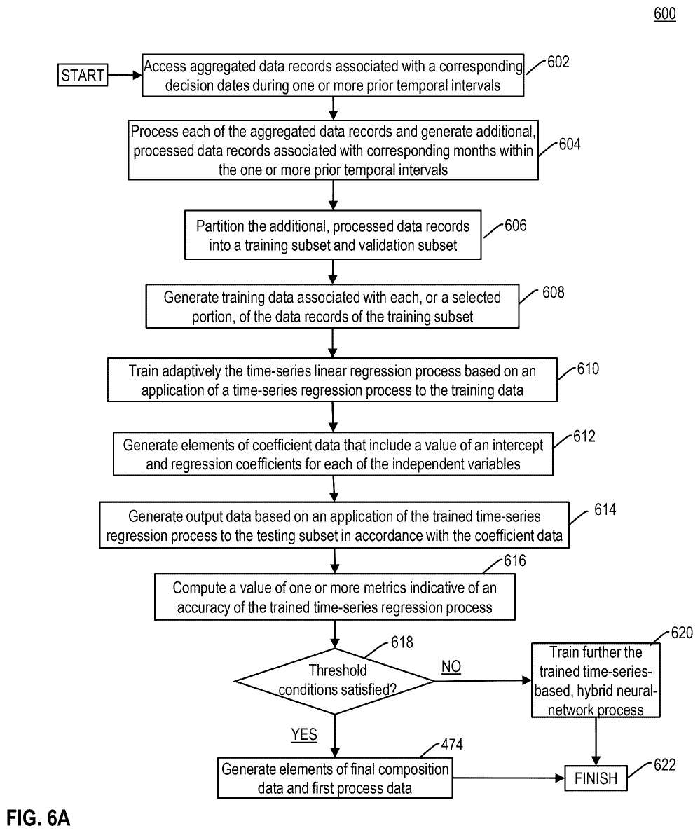

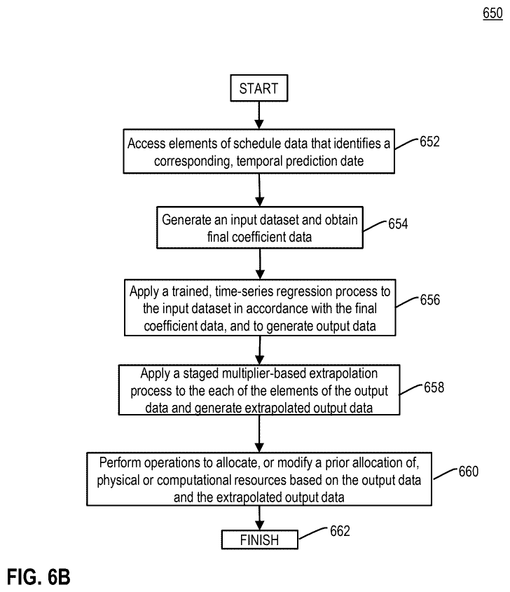

FIG. 6A is a flowchart of exemplary processes for training and testing time-series linear regression processes within a distributed computing environment, in accordance with some examples, one or more of the exemplary processes described herein may utilize partitioned training data associated with a first prior temporal interval (e.g., an in-time training interval), and testing data associated with a second, and distinct, prior temporal interval (e.g., an out-of-time testing interval). In some instances, or more computing systems, such as, but not limited to, one or more of the distributed components of computing system 130, may perform one or more of the steps of exemplary process 600.

Referring to FIG. 6A, computing system 130 may access one or more aggregated data records, each of which may be associated with a corresponding decision date (e.g., in step 602 of FIG. 6A). As described herein, each of the aggregated data records may identify and characterize, among other things, a total number of unique, initial submissions of applications adjudicated manually and programmatically by the organization during the corresponding decision day and may also include values of one or more external indicators during the corresponding decision day.

In some instances, computing system 130 may also perform any of the exemplary processes described herein to process each of the aggregated data records and generate additional, processed data records associated with corresponding months within the one or more prior temporal intervals (e.g., in step 604 of FIG. 6A). As described herein, each of the additional processed data records may include additional temporal data that specifies the corresponding month, an aggregated, total number of unique, initial submissions of applications adjudicated manually and programmatically by the organization during the corresponding month, and average values of the one or more external indicators across the corresponding month.

Computing system 130 may also perform any of the exemplary processes described herein to partition the additional processed data records into a training subset appropriate to train adaptively the time-series linear regression process during the in-time training and validation interval Δt_{train/validate}, and into a testing subset appropriate to test the adaptively trained time-series linear regression process on previously unseen data prior to deployment (e.g., in step 606 of FIG. 6A). In some instances, computing system 130 may perform any of the exemplary processes described herein to generate elements of training data associated with each, or a selected portion, of the additional processed data records of the training subset (e.g., in step 608 of FIG. 6A), and to train adaptively the time-series linear regression process based on an application of a time-series regression process (e.g., an ordinary least squares (OLS) regression process) to each of the elements of training data (e.g., in step 610 of FIG. 6A). Based on the application of the OLS regression process to each of the elements of training data, computing system 130 may generate elements of coefficient data that include a value of an intercept and regression coefficients for each of the independent variables, such as, but not limited to, the numbers of the unique, initial application submissions, the average values of the household interest rates, and the time, and computing system 130 may store the elements of coefficient data within a data repository (e.g., in step 612 of FIG. 6A)

Further, and based on the elements of coefficient data, computing system 130 may access the additional, processed data records of the testing subset, which may be associated with corresponding ones of the months disposed within the one or more prior temporal intervals characterizing testing subset 504, and for each of the elements of the testing subset, computing system 130 may perform operations, consistent with the intercept and regression coefficients within the coefficient data, that compute a predicted number of the unique, initial submissions of applications adjudicated manually and adjudicated programmatically by the organization during each of the successive three months (e.g., in step 614 of FIG. 6A). Based on the actual number of the unique, initial submissions of applications adjudicated manually and adjudicated programmatically by the organization maintained within the elements of the testing subset, and on corresponding ones of the predicted numbers, computing system 130 may also perform any of the exemplary processes described herein to determine a value of the one or more metrics that characterize a performance or accuracy of trained, time-series linear regression process (e.g., in step 616 of FIG. 6A), and to determine whether all, or a selected portion of, the computed metric values satisfy one or more threshold testing conditions (e.g., in step 618 of FIG. 6A).

If, for example, computing system 130 were to establish that one, or more, of the computed metric values fail to satisfy at least one of the threshold testing conditions (e.g., step 618; NO), computing system 130 may establish that the trained time-series linear regression process is insufficiently accurate for a real-time application to the elements of confidential data, and computing system 130 may perform any of the exemplary processes described herein to train further the time-series linear regression process against elements of training data included within additional training datasets (e.g., in step 620 of FIG. 6A). Exemplary process 600 is then complete in step 622.

Alternatively, if computing system 130 were to establish that each computed metric value satisfies the threshold validation conditions (step 618; YES), computing system 130 may deem the trained, time-series linear regression process ready for deployment, and may generate elements of final coefficient data, which includes the intercept and each of the regression coefficients of the trained, trained, time-series linear regression process, and may store the final coefficient data within the data repository (e.g., in step 624 of FIG. 6A). Exemplary process 600 is then complete in step 622.

FIG. 6B is a flowchart of an exemplary process 650 for predicting application number on a monthly basis during a future, target temporal interval, in accordance with some examples. The future temporal interval may, for example, correspond to a three-month temporal interval, and in some instances, one or more computing systems, such as, but not limited to, one or more of the distributed components of computing system 130, may perform one or of the steps of exemplary process 650, as described herein.

Referring to FIG. 6B, computing system 130 may perform operations, described herein, that access elements of schedule data that identifies a corresponding, temporal prediction date (e.g., in step 652 of FIG. 6B). Computing system 130 may perform any of the exemplary processes described herein to generate an input data set that includes an incoming monthly number of applications at the temporal prediction data, an incoming average household interest rate at the temporal prediction date, and time series data (e.g., in step 654 of FIG. 6B), and to obtain elements of final coefficient data, which include the intercept and each of the regression coefficients of the trained, trained, time-series linear regression process (e.g., also in step 654 of FIG. 6B).

Computing system 130 may also perform any of the exemplary processes described herein to apply the trained, time-series regression process to the independent variables included within the input dataset (e.g., the incoming monthly number, the incoming average household interest rate, and the time series data) in accordance with the final coefficient data, and to generate output data that includes an expected, total number of unique, initially submitted applications subject to manual adjudication and programmatic adjudication by the organization during each month of the future, target temporal interval specified within the time series data (e.g., in step 656 of FIG. 6B).

Further, computing system 130 may perform any of the exemplary processes described herein to apply the staged multiplier-based extrapolation process to the each of the elements of the output data (e.g., in step 658 of FIG. 6B). As described herein, each of the elements of output data may include an expected, monthly total number of unique, initially submitted applications subject to manual adjudication and programmatic adjudication by the organization during each month of the future, target temporal interval (e.g., during March, April, and May of 2025). In some instances, within the staged multiplier-based extrapolation process, computing system 130 may obtain a value of a net automation rate associated with the adjudication process, and for each of the elements of output data, computing system 130 may perform any of the exemplary processes described herein to compute, in step 658, a product of (i) the value of net automation rate 542 and (ii) the corresponding regression target variable (e.g., total number of unique, initially submitted applications subject to manual adjudication and programmatic adjudication by the organization during the corresponding month of the future, target temporal interval). Each of these computed products may represent the number of unique, initially submitted applications subject to manual adjudication by the organization during the corresponding month of the future, target temporal interval, and computing system 130 may perform any of the exemplary processes described herein to associate each of these computed products with a corresponding one of the temporal identifiers, and may package the associated pairs of computed products and temporal identifiers into a corresponding element of manual unique submission output data.

Further, and within the staged multiplier-based extrapolation process, computing system 130 may obtain a value of a manual resubmission rate 544 associated with the adjudication process, and for each of the elements of manual unique submission output data, computing system 130 may perform any of the exemplary processes described herein to compute, in step 658, a product of (i) the value of the manual resubmission rate and (ii) the determined number of unique, initially submitted applications subject to manual adjudication by the organization during the corresponding month. As described herein, each of these additional computed products may represent the total number of applications (e.g., initial submissions and resubmissions) subject to manual adjudication by the organization during the corresponding month, and computing system 130 may perform any of the exemplary processes described herein to associate each of these additional computed products with a corresponding one of the temporal identifiers, and may package the associated pairs of determined numbers and temporal identifiers into a corresponding element of total manual submission output data.

Computing system 130 may also perform any of the exemplary processes described herein to perform operations to allocate, or modify a prior allocation of, physical or computational resources to address the expected number of applications subject to adjudication during each month of the future, target temporal interval (e.g., in step 660 of FIG. 6B). In some example, the performed operations may include, but are not limited to, generating elements of allocation data, or re-allocation data, that, when transmitted to adjudication system 306 associated with the organization and with the programmatic, or manual, approval of the applications for the available products or services, controls the operation of that computing system and causes the computing system to allocate, or re-allocate physical and computational resources to address the predicts application numbers on each day of the future temporal interval. Exemplary process 650 is then complete in step 662.

### C. Exemplary Computer-Implemented Processes for Simulating Impacts of Varied Parameters in Adjudication Processing

Upon initial submission of an application for an available product or service, one or more computing systems associated with, or operable by, the organization, such as computing system 130 or adjudication system 306, may perform operations that determine whether the initially submitted application is subject to programmatic adjudication based on, among other things, an established consistency of the application, a corresponding applicant, and the product or service with one or more established adjudication rules. For example, these adjudication rules may render programmatic adjudication available to certain applicants, certain applications, and additionally, or alternatively, to certain products or services (e.g., that do not require significant documentation, etc.).

If computing system 130 or adjudication system 306 were to determine that the initially submitted application is subject to programmatic adjudication by the organization, computing system 130 or adjudication system 306 may process the initially submitted application and render a decision on the application and the requested product or service based one or more adjudication protocols established by the organization and associated with the product or service, and the programmatic decision may include, among other things, a positive decision (e.g., a programmatic approval) or a negative decision (e.g., a programmatic denial).

Alternatively, if computing system 130 or adjudication system 306 were to determine that the initially submitted application is not subject to programmatic adjudication by the organization, adjudication system 306 may determine that the initially submitted application is subject to manual adjudication (e.g., by an underwriter associated with a corresponding underwriter device), and may render available, or provide data, characterizing the initially submitted application, the applicant, and the product or service to the underwriter device. In some instances, the underwriter may review the provisioned data and render a manual decision on the initially submitted application, and the programmatic decision may include, among other things, a positive decision (e.g., a manual approval) or a negative decision (e.g., a manual denial).

As described herein, a programmatic denial or a manual denial of an initially submitted application (or of a resubmitted application) may be associated with, and may result from, one or more errors or omissions within the application, incomplete or absent documentation, or an unsuitability of the requested product or service to a corresponding application. In some instances, an applicant may elect to address the one or more errors or omissions in the initially submitted application or address the incomplete or absent documentation, and the applicant may resubmit the initially submitted, and updated, application with additional documentation to computing system 130 or adjudication system 306, and computing system 130 or adjudication system 306 may apply any of the exemplary adjudication processes described herein to the resubmitted application.

Further, an initially submitted application may be resubmitted to computing system 130 or adjudication system 306 for additional consideration multiple times until that application received a programmatic or a manual approval, or alternatively, until the application is abandoned. Further, in some instances, an initially submitted application (or a resubmitted application subject) subject to a programmatic or manual approval may also be resubmitted to computing system 130 or adjudication system 306 for additional consideration, e.g., responsive to a change in an applicant condition or a modification to a term or condition of the product or service associated with the application.

In some instances, computing system 130 may maintain, within the one or more tangible non-transitory memories (e.g., within centralized data store 132 or aggregated data store 144), data that characterizes a progress of each application for an available product or service within the exemplary adjudication processes described herein from an initial submission, through a manual or programmatic adjudication, through one or more resubmissions, and finally, to a receipt of a programmatic or manual decision, e.g., the programmatic approval, the programmatic denial, and manual approval, and the manual denial. Further, computing system 130 may also associate the time-varying data characterizing a progress of each application for an available product or service within the exemplary adjudication processes with values of one or more external indicators, such as, but not limited to, the external indicators described herein.

While computing system 130 may maintain data characterizing the status of submitted applications at various temporal positions throughout these adjudication processes and associating the status of these submitted applications with values of certain external indicators at the various temporal positions, the complex interrelationship between initial submissions and resubmissions and the multiple decision points of the adjudication process may render difficult an assessment of an impact of a perturbation or change in a parameter of the adjudication process on numbers of initially submitted and/or resubmitted applications subject to programmatic or manual adjudication. For example, the organization may elect to increase an approval rate of initially submitted applications adjudicated programmatically, and in some instances, the increased approval rate may result in not only an increase in the number of initially submitted applications that receive a programmatic approval, but also in increase in the number of application subject to manual review, e.g., as subsets of the number of programmatically applications are resubmitted for further consideration.

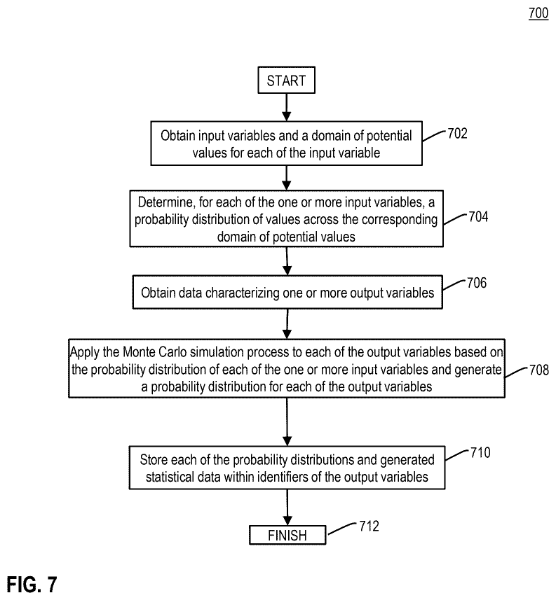

In some instances, described herein in reference to FIG. 7, computing system 130 may perform operations that leverage the historical data characterizing initially submitted and resubmitted applications within the adjudication process over one or more temporal interval to predict an impact of a modification to a value of one or more parameters of the adjudication process on, among other things, a number of initially submitted applications subject to manual or programmatic adjudication, a number of resubmitted applications subject to manual or programmatic adjudication, a rate of programmatic or manual adjudication of initially submitted or resubmitted applications, a rate at which programmatically or manually adjudicated applications are resubmitted, or a likelihood that initially submitted, or resubmitted, applications receive programmatic approval, a programmatic denial, a manual approval, or a manual denial. For example, the modification to the parameter value may be associated with, or be established by the organization, and the performed operations may include an application of one or more stochastic processes, such as a Monte Carlo process, that relies on repeated, random sampling of the maintained historical data to predict the impact of the modified parameter value. Further, in some examples, and output generated through the application of these stochastic process may be provided as an input the trained, time-series-based, hybrid artificial-intelligence process (e.g., to predict application number on a short-term basis) and additionally, or alternatively, as an input to the trained, time-series regression process (e.g., to predict application number on a long-term basis).

FIG. 7 is a flowchart of an exemplary process 700 for simulating an impact of a modification to a process parameter on outcome data using stochastic processes, in accordance with some examples. As described herein, the stochastic processes may include a Monte Carlo simulation process, and in some instances, one or more computing systems, such as, but not limited to, one or more of the distributed components of computing system 130, may perform one or of the steps of exemplary process 700, as described herein.

Referring to FIG. 7, computing system 130 may obtain data characterizing one or more input variables associated with the Monte Carlo simulation process and a domain of potential values for each of the input variable (e.g., in step 702 of FIG. 7). Computing system 130 may also determine, for each of the one or more input variables, a probability distribution of values across the corresponding domain of potential values and may generate statistical data characterizing each of the probability distributions (e.g., in step 704) of FIG. 7).

By way of example, the input variable may correspond to a rate of resubmission of manually or programmatically adjudicated applications, of manually or programmatically approved applications, and/or of manually or programmatically denied applications, an automation rate (e.g., a rate at which initially submitted or resubmitted application are subject to programmatic adjudication), a rate at which an initially submitted or resubmitted application receives a programmatic or manual approval and/or a manual or programmatic denial, or any additional, or alternate, value of a parameter that characterizes the adjudication processes described herein. Further, in some examples, the domain of potential values for the input variable may include a range of potential values (e.g., percentages, etc.) and additionally, or alternatively, a range of values that bound a desired value (e.g., a range of percentages about a desired percentage).

Further, in some examples, computing system 130 may determine that a Gaussian distribution characterizes the values of one, or more, of the independent variables across the corresponding domain of potential values. In other instances, computing system 130 may process one or more elements of data that characterize an independent variable, which may be maintained within the one or more tangible, non-transitory memories (e.g., within aggregated data store 144), and may generate a probability distribution that characterizes the values of that independent variable, e.g., across the one or more prior temporal intervals. The disclosed embodiments are, however, not limited to these exemplary distributions, and in other examples, computing system 130 may determine that any additional, or alternate, probability distribution characterizes the values of one or more of the independent variables across the corresponding domain of values.

For instance, the exemplary application adjudication processes described herein may be characterized by an automation rate of 26%, and an analyst associated with the organization may consider increasing the automation rate up to 35%. The data characterizing the input variables may include an identifier of the automation rate (e.g., one of the input variables), and a range of potential values that characterize the automation rate may include, but is not limited to, a limited range from 20% to 40% or a broader range that encompasses any possible value of the automation rate, e.g., from 0% to 100%. Further, in some instances, computing system 130 may establish that a Gaussian distribution characterizes the values of the automation rate across the continuous domain of values.

Referring back to FIG. 7, may obtain additional data that characterizes one or more output variables for the Monte Carlo simulation process (e.g., in step 706 of FIG. 7). In some instances, the one or more output variables may correspond to discrete decisioning points within the exemplary adjudication process, and may include, but are not limited to, a number of submitted applications (e.g., initially submitted and resubmitted) associated with corresponding ones of a programmatic approval, a programmatic denial, a manual approval, and a manual denial. Additionally, or alternatively, the one or more output variables may include, but are not limited to, a number of unique, initially submitted applications subject to programmatic adjudication or subject to manual adjudication, and further, a number of resubmitted applications subject to programmatic adjudication or subject to manual adjudication. In other instances, the one or more output variables may also characterize various behaviors within the adjudication processes described herein, such as, but not limited to, a rate at which approved applications or declined applications are resubmitted for further adjudication. The disclosed embodiments are, however, not limited to these exemplary output variables, and in other examples, the output variables for the Monte Carlo simulation process may include any additional or alternate variable that characterizes a decision point within, or an operation of, the exemplary adjudication processes described herein.

In some instances, computing system 130 may perform operations that apply the Monte Carlo simulation process to each of the output variables based on the probability distribution of each of the one or more input variables (e.g., in step 708 of FIG. 7), and that generate, for each of the output variables, a probability distribution that characterizes the value of the corresponding output variable across the domain range of the input variable (e.g., also in step 708 of FIG. 7). Computing system 130 may also generate statistical data, such as a mean and a standard deviation, that characterizes each of the probability distributions, and computing system 130 may store each of the probability distributions and the generated statistical data within a portion of the one or more tangible, non-transitory memories in conjunction with an identifier of the corresponding output variable (e.g., in step 710). Exemplary process 700 is then complete in step 712.

In some instances, the exemplary processes described herein may facilitate a generation, by computing system 130, of probability distributions that characterize an impact of a change in the one or more independent variables (e.g., the automation rate described herein) on not only the ultimate disposition of applications within the adjudication process (e.g., the number of submitted applications (e.g., initially submitted and resubmitted) associated with corresponding ones of the programmatic approval, a programmatic denial, a manual approval, and a manual denial), but also at one or more intermediate decision points within the adjudication process (e.g., the number of unique, initially submitted applications subject to programmatic adjudication or subject to manual adjudication, the number of resubmitted applications subject to programmatic adjudication or subject to manual adjudication, etc.) and also on various parameters that characterize the operation of the adjudication process, such as the resubmission rate described herein. Through an implementation of these exemplary processes, computing system 130 may provide an overview of an effect of a potential change across multiple decision points within the adjudication process and may enable the analyst to make a more informed decision regarding the potential change in the input variable, e.g., the automation rate.

Further, in some instances, the output of these exemplary stochastic processes may be provided to, and may inform, one or more of the exemplary predictive processes described herein. For example, the computed numbers of applications generated through the Monto Carlo simulation process may form portions of the input datasets ingested by the trained, time-series-based, hybrid artificial-intelligence processes described herein, and may facilitate a prediction of short-term variations in application adjudication that result from the proposed change to the automation rate. Further, the computed numbers of the applications and additionally, or alternatively, the resubmission or automation rate, may also be leveraged by the trained, time-series regression processes and the staged, multiplier-based extrapolation processes to predict long-term variations in application adjudication that result from the proposed change to the automation rate

### D. Exemplary Computing Architectures

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Exemplary embodiments of the subject matter described in this specification, including, but not limited to, application programming interface (API) 134, ingestion engine 136, pre-processing engine 140, training engine 202, training input module 208, adaptive training module 218, trend module 220A, seasonality module 220B, event module 220C, future regression module 220D, auto-regression (AR) module 220E, lagger AR module 220F, tuning module 238, scheduling engine 302, hybrid prediction engine 308, extrapolation module 320, post-processing engine 324, provisioning engine 326, hybrid regression engine 522, regression module 536, and extrapolation module 540, can be implemented as one or more computer programs, i.e., one or more modules of computer program instructions encoded on a tangible non transitory program carrier for execution by, or to control the operation of, a data processing apparatus (or a computer system).

Additionally, or alternatively, the program instructions can be encoded on an artificially generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The terms “apparatus,” “device,” and “system” refer to data processing hardware and encompass all kinds of apparatus, devices, and machines for processing data, including, by way of example, a programmable processor such as a graphical processing unit (GPU) or central processing unit (CPU), a computer, or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array), an ASIC (application-specific integrated circuit), one or more processors, or any other suitable logic.

Computers suitable for the execution of a computer program include, by way of example, general or special purpose microprocessors or both, or any other kind of central processing unit. Generally, a CPU will receive instructions and data from a read-only memory or a random-access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) receiver, or a portable storage device, such as a universal serial bus (USB) flash drive, to name just a few.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display unit, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a computer having a graphical user interface or a web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow. Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the disclosed embodiments being indicated by the following listing of exemplary claims.

What is claimed is:

1. An apparatus, comprising:
a memory storing instructions;
a communications interface; and
at least one processor coupled to the memory and the communications interface, the at least one processor being configured to execute the instructions to:
obtain event data and indicator data associated with a first temporal interval;
based on an application of a trained artificial intelligence process to an input dataset that includes portions of the event data and the indicator data, generate first output data indicating an expected number of occurrences of a first event during each of a plurality of second temporal intervals disposed subsequent to the first temporal interval;
based on an application of an extrapolation process to the output data, generate second output data indicating an expected number of occurrences of a second event during each of the second temporal intervals; and
perform operations that modify an allocation of a computational resource at a computing system in accordance with the first output data and the second output data.

2. The apparatus of claim 1, wherein:
the portion of the event data specifies a number of occurrences of the first event during the first temporal interval; and
the portion of indicator data comprises at least one indicator value.

3. The apparatus of claim 1, wherein the at least one processor is further configured to execute the instructions to:
obtain data comprising a value of one or more process parameters that characterize the trained artificial intelligence process; and
apply the trained, artificial intelligence process to the input dataset in accordance with the one or more process parameter values.

4. The apparatus of claim 3, wherein:
the trained artificial intelligence process comprises a hybrid artificial intelligence process;
the hybrid artificial intelligence process comprises a decomposable, time-series forecasting process and an auto-regressive neural network; and
the one or more process parameter values comprise a value of at least one additional process parameter of the decomposable, time-series forecasting process and a value of at least one hyperparameter of the auto-regressive neural network.

5. The apparatus of claim 4, wherein the at least one hyperparameter value is tuned in accordance with a Bayesian optimization process.

6. The apparatus of claim 1, wherein the at least one processor is configured to execute the instruction to:
obtain data that characterizes a composition of the input dataset; and
generate the input dataset in accordance with the data that characterizes the composition.

7. The apparatus of claim 1, wherein the at least one processor is further configured to execute the instructions to obtain, from the memory, additional event data that indicates an additional number of occurrences of the first event during each of a plurality of third temporal intervals, the third temporal intervals being disposed prior to the first temporal interval.

8. The apparatus of claim 7, wherein:
the additional event data further specifies an additional number of occurrences of the second event during each of the plurality of third temporal intervals; and
the at least one processor is further configured to execute the instructions to:
determine, for each of the third temporal intervals, a ratio between the additional number of occurrences of the second event and the additional number of occurrences of the first event;
compute an average value of the ratio across each of the third temporal intervals and determine a value of a proxy multiplier based on the computed average value; and
generate, for each of the second temporal intervals, the expected number of occurrences of the second event as a product of the proxy multiplier and the expected number of occurrences of the first event during the corresponding one of the second temporal intervals.

9. The apparatus of claim 7, wherein the at least one processor is further configured execute the instructions to:
perform operations that apply a stochastic process to at least a subset of the additional event data; and
generate at least a portion of the first event data based an output of the applied stochastic process.

10. The apparatus of claim 1, wherein the at least one processor is further configured to execute the instructions to transmit the first output data and the second output data to the computing system via the communications interface, the computing system being configured to modify the allocation of the computational resource in accordance with the first output data and the second output data.

11. A computer-implemented method, comprising:
obtaining, using at least one processor, event data and indicator data associated with a first temporal interval;
based on an application of a trained artificial intelligence process to an input dataset that includes portions of the event data and the indicator data, generating, using the at least one processor, first output data indicating an expected number of occurrences of a first event during each of a plurality of second temporal intervals disposed subsequent to the first temporal interval;
based on an application of an extrapolation process to the output data, generating, using the at least one processor, second output data indicating an expected number of occurrences of a second event during each of the second temporal intervals; and
performing operations, using the at least one processor, that modify an allocation of a computational resource at a computing system in accordance with the first output data and the second output data.

12. The computer-implemented method of claim 11, wherein:
the portion of the event data specifies a number of occurrences of a first event during the first temporal interval; and
the portion of indicator data comprises at least one indicator value.

13. The computer-implemented method of claim 11, further comprising:
obtaining, using the at least one processor, data comprising a value of one or more process parameters that characterize the trained artificial-intelligence process; and
applying, using the at least one processor, the trained, artificial intelligence process to the input dataset in accordance with the one or more process parameter values.

14. The computer-implemented method of claim 13, wherein:
the trained, artificial intelligence process comprises a hybrid artificial intelligence process;
the hybrid artificial intelligence process comprises a decomposable, time-series forecasting process and an auto-regressive neural network; and
the one or more process parameter values comprise a value of at least one additional process parameter of the decomposable, time-series forecasting process and a value of at least one hyperparameter of the auto-regressive neural network, the at least one hyperparameter value being tuned in accordance with a Bayesian optimization process.

15. The computer-implemented method of claim 11, further comprising:
obtaining, using the at least one processor, data that characterizes a composition of the input dataset; and
generating, using the at least one processor, the input dataset in accordance with the data that characterizes the composition.

16. The computer-implemented method of claim 11, further comprising obtaining, using the at least one processor, additional event data that indicates an additional number of occurrences of the first event during each of a plurality of third temporal intervals, the third temporal intervals being disposed prior to the first temporal interval.

17. The computer-implemented method of claim 16, wherein:
the additional event data further specifies an additional number of occurrences of the second event during each of the plurality of third temporal intervals; and
generating the second output data comprises:
determining, using the at least one processor, for each of the third temporal intervals, a ratio between the additional number of occurrences of the second event and the additional number of occurrences of the first event;
using the at least one processor, computing an average value of the ratio across each of the third temporal intervals and determining a value of a proxy multiplier based on the computed average value; and
generating, using the at least one processor, for each of the second temporal intervals, the expected number of occurrences of the second event as a product of the proxy multiplier and the expected number of occurrences of the first event during the corresponding one of the second temporal intervals.

18. The computer-implemented method of claim 16, further comprising:
performing operations, using the at least one processor, that apply a stochastic process to at least a subset of the additional event data; and
generating, using the at least one processor, at least a portion of the first event data based an output of the applied stochastic process.

19. The computer-implemented method of claim 1, further comprising transmitting, using the at least one processor, the first output data and the second output data to the computing system, the computing system being configured to modify the allocation of the computational resource in accordance with the first output data and the second output data.

20. A tangible, non-transitory computer-readable medium storing instructions that, when executed by at least one processor, cause the at least one processor to perform a method, comprising:
obtaining event data and indicator data associated with a first temporal interval;
based on an application of a trained artificial intelligence process to an input dataset that includes portions of the event data and the indicator data, generating first output data indicating an expected number of occurrences of the first event during each of a plurality of second temporal intervals disposed subsequent to the first temporal interval;
based on an application of an extrapolation process to the output data, generating second output data indicating an expected number of occurrences of a second event during each of the second temporal intervals; and
performing operations that modify an allocation of a computational resource at a computing system in accordance with the first output data and the second output data.
